(19) United States
(12) Patent Application Publication
(10) Pub. No.: US 2022/0317012 A1
(43) Pub. Date: Oct. 6, 2022

(54) PARTICLE, INCLUDING SARS-COV-2, DETECTION AND METHODS THEREFOR

(71) Applicant: Martin Terence COLE, South Melbourne (AU)

(72) Inventor: Martin Terence COLE, South Melbourne (AU)

(21) Appl. No.: 17/660,007

(22) Filed: Apr. 20, 2022

Related U.S. Application Data
(63) Continuation-in-part of application No. PCT/AU2020/051128, filed on Oct. 20, 2020.

(30) Foreign Application Priority Data
Oct. 21, 2019 (AU) 2019903950
Aug. 11, 2020 (AU) 2020902830
Apr. 20, 2021 (AU) 2021901161

(51) Int. Cl. G01N 15/02; G01N 21/53; G01N 15/14

(52) U.S. Cl. CPC G01N 15/0211; G01N 21/53; G01N 15/1459; G01N 2015/0046

(57) ABSTRACT

The present disclosure relates to determining, in a fluid sample, particle(s) having a predetermined size or range of sizes within a detection zone using a particle detector, and includes: providing first and second lights to illuminate the sample within the detection zone; the first light being: a first polarisation at a first wavelength; a single wavelength having a first polarisation; or an unpolarised first wavelength; the second light being: a second polarisation at a second wavelength; the single wavelength having a second polarisation; or an unpolarised second wavelength; first sensor means obtaining a first response signal responsive to the first light impinging a particle; a second sensor means obtaining a second response signal responsive to the second light impinging a particle; determining a light scattering intensity at each light and a quotient thereof; and determining size of particle(s) by correlating light intensity values with values in a look-up table.

### CROSS-REFERENCE TO RELATED APPLICATIONS

The present application is a continuation-in-part of International Patent Application No. PCT/AU2020/051128, entitled “IMPROVEMENTS RELATED TO PARTICLE, INCLUDING SARS-COV-2, DETECTION AND METHODS THEREFOR,” filed Oct. 20, 2020. International Patent Application No. PCT/AU2020/051128 claims priority to Australian Patent Application No. 2019903950, filed Oct. 21, 2019, and to Australian Patent Application No. 2020902830, filed Aug. 11, 2020. The entire contents of the above-listed applications are hereby incorporated by reference for all purposes.

### TECHNICAL FIELD

The present disclosure relates to the field of the detection, analysis and/or determination of matter or particles, including the SARS-CoV-2 virus, suspended in fluid.

In one particular form, according to one aspect of the disclosure, the present disclosure relates to smoke detectors, which detect unwanted pyrolysis or combustion of material. In another form, the present disclosure relates to smoke detectors of the early detection type, and which may be applied to ventilation, air-conditioning or duct monitoring of a particular area. In another, form the present disclosure relates to aspirated smoke detection. In yet another form, the present disclosure relates to surveillance monitoring, such as building, fire or security monitoring. In still another form, according to a second aspect of the disclosure, the present disclosure relates to a nephelometer, particle counter and/or more general environment monitoring, such as monitoring, detection and/or analysis of particles in a fluid, zone, area and/or ambient environment, including commercial and industrial environments and including outdoor areas including a neighbourhood. In this second aspect, embodiments of the disclosure relate to particle detectors, including detectors adapted to detect SARS-CoV-2 virus particles (responsible for the COVID-19 pandemic) in breath samples exhaled from a person. In yet another form, the present disclosure relates to the detection of airborne microbes such as but not limited to the SARS-CoV-2 virus, desirably within exhaled air or within an area that may contain contaminated air. The SARS-CoV-2 detector may be a portable device or a larger in-situ device.

It will be convenient to hereinafter describe the disclosure in relation to smoke detectors of the early detection type, in one embodiment, and in relation to a particle detector for SARS-CoV-2 particles in a second embodiment, however, it should be appreciated that the present disclosure is not limited to that use only. As will become apparent, the present disclosure has broad application and thus the particular forms noted above are only given by way of example, and the scope of the present disclosure should not be limited to only these forms.

### BACKGROUND

Throughout this specification, the use of the word “inventor” in singular form may be taken as a reference to one (singular) inventor or more than one (plural) inventor of the present disclosure.

Any discussion of the background art throughout the specification should in no way be considered as an admission that such background art is prior art, nor that such background art is widely known or forms part of the common general knowledge in the field in Australia or worldwide as at the priority date of the present application.

All references, including any patents or patent applications, cited in this specification are hereby incorporated by reference, which means that it should be read and considered by the reader as part of this text. That the document, reference, patent application or patent cited in this text is not repeated in this text is merely for reasons of conciseness.

No admission is made that any reference or documentation cited in the present specification constitutes prior art. The discussion of the references states what their authors assert, and the applicants reserve the right to challenge the accuracy and pertinence of the cited documents. It will be clearly understood that, although a number of prior art publications may be referred to herein, such reference does not constitute an admission that any of these documents forms part of the common general knowledge in the art, in Australia or in any other country, at the priority date of the application.

It is to be appreciated that any discussion of documents, devices, acts or knowledge in this specification is included to explain the context of the present disclosure. Further, the discussion throughout this specification comes about due to the realisation of the inventor and/or the identification of certain related art problems by the inventor. Moreover, any discussion of material such as documents, devices, acts or knowledge in this specification is included to explain the context of the disclosure in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure herein.

The present inventor has identified that the type of smoke produced in various pyrolysis and combustion circumstances is different. Fast flaming fires tend to produce a very large number of very small solid particles (such as carbonaceous spheres) which may agglomerate into random shapes to form soot. In contrast, the early stages of pyrolysis tend to produce a much smaller number of relatively large liquid particles (of high boiling point), typically existing as aerosols that may agglomerate to form larger, translucent spheres.

The present inventor has also identified that the detection of relatively large particles which slowly increase in quantity over an extended period of time would typically indicate a pyrolysis or smouldering condition, whereas the detection of numerous small particles arising quickly and without earlier pyrolysis or smouldering could indicate arson involving the use of accelerants.

The present inventor has further identified that dust particles are generated by the abrasion or non-thermal decomposition of natural materials or organisms in the environment and that such particles are in general very large and have different morphology compared with smoke particles.

The present inventor has also identified that in order reliably to provide the earliest warning of overheating, smouldering, pyrolysis or flaming fire, it is necessary to avoid false alarms caused by dust and steam.

The present inventor has also determined that airborne microbes are particles that, according to their species, have a particular size or range of sizes that can be used to determine their presence and abundance. The present inventor has realised that microbes are detectable despite often being suspended in water or other fluid droplets.

The present inventor has also realised that there is a need to improve particle detection, especially for particle sizes in the range of 1 μm or less.

The present inventor has still further identified that conventional point type smoke detectors are primarily designed for ceiling installation in a protected area. These point type detectors have relatively low sensitivity and therefore provide relatively late warning of a pyrolysis event. This late warning could result in serious damage and injury that could otherwise be avoidable. Moreover, these point type detectors have difficulty in detecting the presence of pyrolysis where large volumes of air pass through the area being monitored, thus diluting the ability of the point type detector to sense the presence of pyrolysis.

The present inventor has realised that highly sensitive aspirated smoke detectors were developed, and are often deployed on ducts, pipes or tubes to monitor an area. These detectors provide a measure of sensitivity some hundreds of times greater than conventional point-type detectors. These aspirated systems employ suction pressure via an air pump and usually employ a dust filter to reduce unwanted dust pollution from soiling the detector or from being detected indistinguishably from smoke and causing the triggering of a false alarm.

The aspirated smoke detector employed in an aspirated system may be a nephelometer. This is a detector sensitive to many sizes of particles, such as the many smoke particles produced in fires or during the early stages of overheating, smouldering or pyrolysis.

The present inventor has realised that some prior art smoke (or airborne particle) detectors use an optical-based detector, such as a single light source to illuminate a detection chamber that may contain particles to be detected. The use of two light sources has also been employed for some detectors. In use, a proportion of light from the light source may be scattered off the detected particles toward one or more receiver cells (or sensors). The output signal(s) from the receiver cell(s) is used to trigger an alarm signal.

The present inventor also realises that ionisation type smoke detectors, on the other hand, utilise a radioactive element such as Americium 241, to ionise the air within the detection chamber. These ionisation detectors are relatively sensitive to very small particles produced in flaming fires but are relatively insensitive to the larger particles produced in overheating, smouldering or pyrolysis. The ionisation detectors have also been found relatively prone to draughts, which serve to displace the ionised air within the detection chamber and thus can trigger a false alarm. This limits their usefulness and application.

The present inventor has identified that still other smoke detectors have used a Xenon lamp as a single light source. The Xenon lamp produces a continuous spectrum of light, similar to sunlight, embracing ultraviolet, visible and infrared wavelengths. Use of this light source can detect most sizes of particles and the detectors produce a signal that is proportional to the mass density of the smoke, which is characteristic of a true nephelometer. However, the present inventor has identified a problem that the type of fire cannot be characterised because the particular particle size or range of sizes cannot be discerned. The Xenon light also has only a relatively short life-span of some 4 years and its light intensity is known to vary, which can affect the sensitivity of the detector.

The present inventor realises that, yet other smoke detectors use a laser beam, providing a polarised monochromatic light source, typically of infrared wavelength. These detectors, however, are not considered to be true nephelometers as they are prone to being overly sensitive to a particular range of particle sizes and not as sensitive to other particle size ranges. One disadvantage suffered by these detectors, and noted by the present inventor, is their relative insensitivity to very small particles characteristic of early pyrolysis and incipient fires, as well as certain flaming fires. The present inventor has realised that this insensitivity is because the wavelength of any infrared laser beam is too large compared with the size of very small particles.

The present inventor has previously designed a detector having a pair of LED projectors of differing wavelength (colour), together with a single receiver for detecting light scattered off airborne particles, within an air-sampling chamber [WO200159737, WO2005043479 and WO2008064396]. These colours and wavelengths are typically blue (470 nm) and infrared (940 nm). Because of its relatively short wavelength, the present inventor has found that blue light reveals the very small particles invisible to infrared light. The inclusion of the second, infrared light source enables discrimination between these small particles and the relatively large particles characteristic of dust and steam. The blue and infrared projectors can be pulsed alternately to produce two independent signals from the one receiver. By subtraction of the infrared signal from the blue signal, the detector can provide some warning of overheating, smouldering, pyrolysis or fire whilst avoiding false alarms caused by dust or steam. Because the LED projector beams are relatively wide and relatively incoherent, these LED detectors have been found by the present inventor to require an air-sampling chamber which has the disadvantage of being relatively large in size, complex and costly.

An object of the present disclosure is to provide a particle detection apparatus and/or method(s) which enable an improved detection, discrimination and/or analysis of particles, overheating, smouldering, pyrolysis and/or flaming events and dust, thus providing a corresponding improvement in fluid-borne particle detection.

A further object of the present disclosure is to provide a detection apparatus and/or method which will enable improved detection, discrimination and/or analysis of predetermined and/or selected particles or aerosols with, without limitation including microbes, particle sizes in the range of 10 μm or less, such as particle sizes in the range of 1 μm or less, SARS-CoV-2 particles (responsible for COVID-19) and/or any combination thereof.

A still further object of the present disclosure is to alleviate at least one disadvantage associated with the prior art.

### SUMMARY

It is an object of the present disclosure to overcome or ameliorate at least one or more of the disadvantages of the prior art, or to provide a useful alternative.

Unless defined otherwise, all technical and scientific terms used herein have the same meaning as commonly understood by those of ordinary skill in the art to which the disclosure belongs. It will be further understood that terms used herein should be interpreted as having a meaning that is consistent with their meaning in the context of this specification and the relevant art and will not be interpreted in an idealized or overly formal sense unless expressly so defined herein. For the purposes of the present disclosure, additional terms are defined below. Furthermore, all definitions, as defined and used herein, should be understood to control over dictionary definitions, definitions in documents incorporated by reference, and/or ordinary meanings of the defined terms unless there is doubt as to the meaning of a particular term, in which case the common dictionary definition and/or common usage of the term will prevail.

For the purposes of the present disclosure, the following terms are defined below.

The articles “a” and “an” are used herein to refer to one or to more than one (i.e. to at least one) of the grammatical object of the article. By way of example, “an element” refers to one element or more than one element.

The term “about” is used herein to refer to quantities that vary by as much as 30%, or by as much as 20%, or by as much as 10% to a reference quantity. The use of the word ‘about’ to qualify a number is merely an express indication that the number is not to be construed as a precise value.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others. Thus, “including” is synonymous with and means “comprising”.

In the summary above and the description below, all transitional phrases such as “comprising,” “including,” “carrying,” “having,” “containing,” “involving,” “holding,” “composed of,” and the like are to be understood to be open-ended, i.e., to mean “including but not limited to”. Only the transitional phrases “consisting of” and “consisting essentially of” alone shall be closed or semi-closed transitional phrases, respectively.

The term, “real-time”, for example “displaying real-time data,” refers to the display of the data without intentional delay, given the processing limitations of the system and the time required to accurately measure the data. Similarly, a process occurring “in real time” refers to operation of the process without intentional delay or in which some kind of operation occurs simultaneously (or nearly simultaneously) with when it is happening.

The term, “near-real-time”, for example “obtaining real-time or near-real-time data” refers to the obtaining of data either without intentional delay (“real-time”) or as close to real-time as practically possible (i.e. with a small, but minimal, amount of delay whether intentional or not within the constraints and processing limitations of the of the system for obtaining and recording or transmitting the data.

Although any methods and materials similar or equivalent to those described herein can be used in the practice or testing of the present disclosure, methods and materials are described. It will be appreciated that the methods, apparatus and systems described herein may be implemented in a variety of ways and for a variety of purposes. The description here is by way of example only.

Throughout the specification, the detection apparatus and/or detection method as disclosed herein as well as aspects of the disclosure disclosed herein function to determine, within a detection zone, the presence of particles and/or aerosols that can be considered a group of particles suspended in fluid, air or other gas. Reference herein to ‘particle’ may also include particles in aerosol, and reference to ‘aerosol’ may include one or more particles within the aerosol.

Throughout the specification, particle sizes are defined in reference to an optical diameter of 1.0 micron. For practical purposes, it is a range of 1.0 to 1.2 micron (the available range for the ‘selected boundary’). Optical diameter is an apparent size as measured optically. Another size regime is aerodynamic diameter which is used in Stokes equations. Aerosols are also measured as mass mean diameter, or diameter of average mass, depending on the measuring process available and statistical methods used. The ‘selected boundary’ is illustrated in FIGS. 1 and 2—a selected point where the green and infrared signals converge. The quotient (FIG. 2) (e.g. see Equations 9 or 10) is adjustable in the range of about 1.1 to 1.0 to select the notional boundary between dust and smoke. Furthermore:

very small particles can be arbitrarily taken as approximately <0.1 micron;

small particles are approximately <1 micron;

large particles can be taken as approximately >1.2 micron;

very large particles can be arbitrarily taken as approximately >10 micron;

‘smoke aerosols’ are typically composed of particles approximately <1 micron; and

“dust” or “steam” (water vapour) aerosols are typically composed of particles approximately >1.2 micron.

Throughout the specification, various colours and wavelengths are referred to, which fall into the following approximate ranges (±about 5-10 nm):

| | |
|---|---|
| Infrared | 1600-780 nm |
| Red | 780-620 nm |
| Orange | 620-600 nm |
| Yellow | 600-570 nm |
| Green | 570-490 nm |
| Blue | 490-440 nm |
| Violet | 440-390 nm |
| Ultraviolet | 390-200 nm |

In one aspect of the disclosure, Green and Blue wavelength(s) may be referred to as visible wavelength(s).

Throughout this document, the factors, values and/or coefficients shown in equations are for illustration only, reflecting particular, but not every embodiment, and as such the exact value of these factors, values and/or coefficients depend upon the calibration and/or use of the disclosure.

When configured as a particle counter, the disclosure may be used to determine the size and/or refractive index of a particle within an aerosol. When configured as a nephelometer, the disclosure may be used to determine the statistical mean values of the size and/or refractive index of the particles within the aerosol.

In a first aspect of embodiments described herein there is provided a method of, detector and/or apparatus for detecting the presence of particle(s) having a predetermined size or range of sizes within a detection zone using a particle detector, comprising providing a first light and a second light, the first light being adapted to illuminate the sample within the detection zone, the second light also being adapted to illuminate the sample within the detection zone, the first light being one of a first polarisation at a first wavelength; a single wavelength having a first polarisation; or an unpolarised first wavelength, the second light being one of a second polarisation at a second wavelength; the single wavelength having a second polarisation; or an unpolarised second wavelength, providing a first sensor means adapted to obtain a first response signal responsive to the first light impinging a particle, providing a second sensor means adapted to obtain a second response signal responsive to the second light impinging a particle, based on the first response signal and the second response signal provided by the particle, determining a light scattering intensity at each light and a quotient thereof, determining size of particle(s) by correlating the light intensity values with values stored in a look-up table.

In a second aspect of embodiments described herein there is provided a method of, detector and/or apparatus for detecting the size or range of sizes of at least one particle in a fluid sample, comprising providing a detection zone; providing, in the detection zone, a first light; providing, in the detection zone, a second light, different from the first light; the first light being one of a first polarisation at a first wavelength; a single wavelength having a first polarisation; or an unpolarised first wavelength, the second light being one of a second polarisation at a second wavelength; the single wavelength having a second polarisation; or an unpolarised second wavelength, providing a first detector adapted to the receive first scattered light from a particle(s) in the detection zone in response to the first light and in response to a fluid flow containing particle(s) in the detection zone; providing a second detector adapted to the receive second scattered light off a particle in the detection zone in response to the second light and also in response to the fluid flow containing particle(s) in the detection zone; by using the output of the first detector and/or the second detector, determining the size or range of sizes of at least one particle in the fluid sample based on at least intensity of the first scattered light and/or intensity of the second scattered light at a refractive index or a range of refractive indices.

In a third aspect of embodiments described herein, there is provided a disposable outlet filter capsule incorporating a transparent spherical region forming a chamber and adapted, in association with a particle detector, such as disclosed herein, to be located proximate an area of laser focus, the chamber forming the zone in which particles are illuminated with light from the laser and from which light scattered in response to the presence of particles can be emitted to obtain signals for processing by the particle detector.

In some embodiments, the look-up table values are obtained from the light scattering equations of Gustav Mie, applicable to the wavelength and polarisations in use.

In some embodiments, the look-up table values are obtained through a machine learning process where the disclosure is exposed to a range of known particle species in order to characterise said species, and the intensities of scattered light obtained are stored in the look-up table for later use.

In some embodiments, the look-up table includes quotients of the values obtained for each polarisation as a means for rapidly closing upon a solution to the process of obtaining the particle size and refractive index of particle(s) in view.

In some embodiments, the step of correlating light intensity and/or the quotient determines the size and also the refractive index of the particle(s).

In some embodiments, the light intensity is measured as an amplitude.

In some embodiments, the first sensor means is responsive to normal polarisation light.

In some embodiments, the second sensor means is responsive to parallel polarisation light.

In some embodiments, the quotient is determined by an equation of the form:

Quotient (Q)=GN/GP

where:

GN is the signal with Normal polarisation; and

GP is the signal with Parallel polarisation.

In some embodiments, the particle is or is indicative of SARS-CoV-2.

In some embodiments, the light source may be a single light source or more than one light source.

In some embodiments, the first sensor means is responsive to green light wavelength(s).

In some embodiments, the first sensor means is responsive to blue light wavelength(s).

In some embodiments, the first sensor means is responsive to visible light wavelength(s).

In some embodiments, the second sensor means is responsive to infrared light wavelength(s).

In some embodiments, the sample is illuminated by the first wavelength and the second wavelength at the same time.

In some embodiments, the first sensor means is responsive to a combined visible and infrared light.

In some embodiments, the second sensor means is responsive to visible and infrared light.

In some embodiments, the light source is an infrared laser and the optical medium is a nonlinear optical medium adapted to convert the fundamental infrared laser light from the infrared laser to one or more further laser beams with a frequency shifted wavelength. For example, the nonlinear medium may be a frequency doubling nonlinear medium adapted to convert a fundamental infrared laser beam to produce a frequency-doubled visible output laser beam as the first wavelength in addition to residual invisible infrared light as the second wavelength.

Example nonlinear media for frequency shifting an infrared laser beam to provide a visible output laser beam include, among many others, potassium dihydrogen phosphate KH₂PO₄ (KDP); bismuth triborate BiB₃O₆ (BIBO), Bismuth Borate β-BaB₂O₄ (BBO) or Lithium triborate LiB₃O₅ (LBO).

In a particular example embodiment, the infrared laser may be a neodymium-doped yttrium aluminium garnet (Nd:YAG) solid-state laser source. The Nd:YAG laser may operate at one of a selected few infrared wavelengths e.g. 1064 nm or 946 nm (four-level or three-level laser operation respectively) which can be coupled with a nonlinear optical medium such as, for example, BIBO, to convert a portion of the infrared output and respectively generate a frequency-doubled output at 532 nm (visible/green) or 473 nm (visible/blue). In this manner, the output from the light source comprises a portion of visible laser radiation and a portion of infrared laser radiation, being the residual fundamental laser radiation not converted by the nonlinear optical medium.

In some embodiments, the logic means subtracts infrared light or visible light from the combined visible and infrared light to obtain a visible or infrared light response, respectively.

In some embodiments, the first sensor and/or the second sensor is responsive to visible light.

In some embodiments, the optical medium is a KDP crystal.

In some embodiments, the light source is a green laser.

In some embodiments, the optical medium is a BIBO crystal.

In some embodiments, the light source is a blue laser.

In some embodiments, the first and the second sensor means are substantially the same types of sensor, the first sensor having a first filter to provide sensitivity to the first wavelength, and the second sensor having a second filter to provide sensitivity to the second wavelength.

In some embodiments, an achromatic lens is provided for aligning the first and second wavelengths of light.

In some embodiments, a beam dump is provided.

In some embodiments, the detection zone is light-tight.

In some embodiments, the light source is a single source of light.

In some embodiments, the light source is pulsed.

In an embodiment, the detector apparatus and/or method is adapted to function as or part of a breathalyser.

In some embodiments, the fluid sample is of a person's breath.

In some embodiments, the particle is or is indicative of SARS-CoV-2.

In some embodiments, the intensity of the first and second scattered light is used.

In some embodiments, the determination is displayed, such as to represent the number of particles counted at each refractive index and/or particle size.

There are numerous other possible laser sources that can be used as an alternative single light source operating with similar fundamental output wavelengths, as would be appreciated by the skilled addressee. For example, Nd-doped vanadate (Nd:YVO₄) having a fundamental laser transition of 1064 nm or Nd:YLF (yttrium lithium fluoride) having selectable fundamental lasing transitions at 1047 nm and 1053 nm which when frequency-doubled provide additional visible output light at either 523 nm or 526 nm. The single laser light source may also be selected to operate with a longer fundamental output wavelength, which when coupled with a nonlinear optical medium to generate visible light in the red region of the optical spectrum, for example, among others, Nd:YLF can be frequency doubled to generate output light in the red at 660.5 nm and 657 nm; or Nd:YAG can be operated to generate output in the red at 660 nm. It will be appreciated that, due to the wavelength-dependent nature of light scattering from particles, light sources having shorter generated wavelengths in the green, blue or shorter (violet, or ultraviolet) may be used for detection of smaller particle sizes and it is not to be assumed that one or more of the wavelengths of light generated by the light source and used for the particle detection must include a visible wavelength (however for purposes of clarity in the description herein consistent with many particular possible embodiments of the single light source, a frequency converted beam is generally referred to herein as a visible wavelength).

In essence, embodiments of the present disclosure stem from the realization that the exposure of the same particle or cloud of particles to uniquely polarised light beams, for example mutually independent perpendicularly polarised light (i.e. Normal or Parallel polarisations) of a light beam of a particular wavelength, or two unpolarised light beams of different wavelengths (any one of which, or any combination of which may be used in association with an appropriate look-up table), enables relatively consistent analysis of the particle or cloud of particles by using at least two receivers responsive (respectively) to each wavelength or polarisation of light. In other words, the present disclosure has found improved accuracy and/or responsiveness to detection by the use of multiple light sources and/or in association with a lookup table and/or based on the intensity of scattered light at a refractive index or a range of refractive indices provide consistency in analysis of the resultant signals.

According to a third aspect of the disclosure, there is provided a method of determining, in a fluid sample, the presence of particle(s) having a predetermined size or range of sizes within a detection zone using a particle detector, the method comprising: providing a light beam adapted to illuminate the sample within the detection zone; providing a first sensor means adapted to obtain a first response signal responsive to light from the light beam scattered from a particle in the fluid sample at a first polarisation; providing a second sensor means adapted to obtain a second response signal responsive to light from the light beam scattered from a particle in the fluid sample at a second polarisation; based on the first response signal and the second response signal provided by the particle, determining a light scattering intensity at each of the first and second polarisations and a quotient thereof; and determining size of particle(s) by correlating the light scattering intensity values with values stored in a lookup table.

The light beam may be polarised.

The lookup table values may be obtained with reference to the light scattering equations of Gustav Mie, and being applicable to the wavelength and/or polarisations of the application of the method.

The lookup table values may be obtained through a machine learning process where the method is used in association with a range of known particle species in order to characterise said species, and the intensities of scattered light obtained are stored in the lookup table for reference in identifying that species.

The lookup table may include a quotient of the values obtained with reference to determining the particle size and refractive index of the particle(s).

The step of correlating light intensity and/or the quotient may determine the size and also the refractive index of the particle(s).

The light intensity may be measured as an amplitude.

The first sensor means may be responsive to normal polarisation light. The second sensor means may be responsive to parallel polarisation light.

The quotient may be determined by an equation of the form:

Quotient (Q)=GN/GP

where:

GN is the signal received by the first receiver with Normal polarisation; and

GP is the signal received by the second receiver with Parallel polarisation.

The particle may be or may be indicative of SARS CoV 2.

According to a fourth aspect of the disclosure, there is provided a particle detector adapted to determine, in a fluid sample, the presence of particle(s) having a predetermined size or range of sizes within a detection zone, the detector comprising: a light source adapted to provide a light beam adapted to illuminate the sample within the detection zone; first sensor means adapted to obtain a first response signal indicative of the presence of particle(s) responsive to light from the light beam scattered from a particle in the sample at a first polarisation; second sensor means adapted to obtain a second response signal indicative of the presence of particle(s) responsive to light from the light beam scattered from a particle in the sample at a second polarisation; logic means adapted to process the first response signal and the second response signal in order to determine the presence of particle(s) responsive to each polarisation of scattered light based on reference to light intensity stored in a lookup table.

The light beam may be polarised.

The lookup table values may be obtained with reference to the light scattering equations of Gustav Mie, and being applicable to the wavelength and/or polarisations of the application of the method.

The lookup table values may be obtained through a machine learning process where the method is used in association with a range of known particle species in order to characterise said species, and the intensities of scattered light obtained are stored in the lookup table for reference in identifying that species.

The lookup table may include a quotient of the values obtained with reference to determining the particle size and refractive index of particle(s).

The first sensor means may be responsive to normal polarisation light and further wherein the second sensor means is responsive to parallel polarisation light.

The light source may be a single wavelength light source.

The light source may be a polarised light source.

The particle may be or may be indicative of SARS CoV 2.

According to a fifth aspect of the disclosure, there is provided a method of detecting the size or range of sizes of at least one particle in a fluid sample, the method comprising: providing a detection zone; providing, in the detection zone, a light beam; providing a first detector adapted to the receive first scattered light at a first polarisation from a particle(s) in the detection zone in response to the light beam and in response to a fluid flow containing particle(s) in the detection zone; providing a second detector adapted to the receive second scattered light at a second polarisation off a particle in the detection zone in response to the light beam and also in response to the fluid flow containing particle(s) in the detection zone; by using the output of the first detector and/or the second detector, determining the size or range of sizes of at least one particle in the fluid sample based on at least intensity of the first scattered light and/or intensity of the second scattered light at a refractive index or a range of refractive indices.

The intensity of the first and second scattered light may be used.

The determination may be displayed, such as to represent the number of particles counted at each refractive index and/or particle size.

According to a sixth aspect of the disclosure, there is provided a particle detection zone adapted for use with a particle detector for detecting the size or range of sizes of at least one particle in a fluid sample, the detection zone comprising: a disposable outlet filter capsule incorporating a transparent spherical region forming a chamber and adapted, in association with the particle detector, to be located proximate an area of laser focus, the chamber forming the zone in which particles are impinged with light from the laser and from which light scattered in response to the presence of particles can be emitted so as to obtain signals for processing by the particle detector.

According to an seventh aspect of the disclosure, there is provided a method of determining, in a fluid sample, the presence of particle(s) having a predetermined size or range of sizes within a detection zone using a particle detector, the method comprising: providing a first light and a second light; the first light being adapted to illuminate the sample within the detection zone; the second light also being adapted to illuminate the sample within the detection zone; the first light being one of: a first polarisation at a first wavelength; a single wavelength having a first polarisation; or an unpolarised first wavelength; the second light being one of: a second polarisation at a second wavelength; the single wavelength having a second polarisation; or an unpolarised second wavelength; providing a first sensor means adapted to obtain a first response signal responsive to the first light impinging a particle; providing a second sensor means adapted to obtain a second response signal responsive to the second light impinging a particle; based on the first response signal and the second response signal provided by the particle, determining a light scattering intensity at each light and a quotient thereof; and determining size of particle(s) by correlating the light intensity values with values stored in a lookup table.

The lookup table values may be obtained with reference to the light scattering equations of Gustav Mie, and being applicable to the wavelength and/or polarisations of the application of the method. The lookup table values may eb obtained through a machine learning process where the method is used in association with a range of known particle species in order to characterise said species, and the intensities of scattered light obtained are stored in the lookup table for reference in identifying that species.

The lookup table may include a quotient of the values obtained with reference to determining the particle size and refractive index of particle(s).

The step of correlating light intensity and/or the quotient may determine size and also refractive index of particle(s).

The light intensity may be measured as an amplitude.

The first sensor means may be responsive to normal polarisation light. The second sensor means may be responsive to parallel polarisation light.

The quotient may be determined by an equation of the form:

Quotient (Q)=GN/GP

where:

GN is the signal with Normal polarisation; and

GP is the signal with Parallel polarisation.

The particle may be or may be indicative of SARS CoV 2.

According to an eighth aspect of the disclosure, there is provided a particle detector adapted to determine, in a fluid sample, the presence of particle(s) having a predetermined size or range of sizes within a detection zone, the detector comprising: a light source adapted to provide both a first light and a second light; the first light being adapted to illuminate the sample within the detection zone; the second light also being adapted to illuminate the sample within the detection zone; the first light being one of: a first polarisation at a first wavelength; a single wavelength having a first polarisation; or an unpolarised first wavelength; the second light being one of: a second polarisation at a second wavelength; the single wavelength having a second polarisation; or an unpolarised second wavelength; first sensor means adapted to obtain a first response signal indicative of the presence of particle(s) responsive to the first light; second sensor means adapted to obtain a second response signal indicative of the presence of particle(s) responsive to the second light; and logic means adapted to process the first response signal and the second response signal in order to determine the presence of particle(s) responsive to each wavelength of light based on reference to light intensity stored in a lookup table.

The lookup table values may be obtained with reference to the light scattering equations of Gustav Mie, and being applicable to the wavelength and/or polarisations of the application of the method. The lookup table values may be obtained through a machine learning process where the method is used in association with a range of known particle species in order to characterise said species, and the intensities of scattered light obtained are stored in the lookup table for reference in identifying that species. The lookup table may include a quotient of the values obtained with reference to determining the particle size and refractive index of particle(s).

The first sensor means may be responsive to normal polarisation light and further the second sensor mans may be responsive to parallel polarisation light. The light source may be a single light source.

The sample may be illuminated by the first polarisation and the second polarisation at the same time.

The particle may be or may be indicative of SARS CoV 2.

According to a ninth aspect of the disclosure, there is provided a method of detecting the size or range of sizes of at least one particle in a fluid sample, the method comprising: providing a detection zone; providing, in the detection zone, a first light; providing, in the detection zone, a second light, different from the first light; the first light being one of: a first polarisation at a first wavelength; a single wavelength having a first polarisation; or an unpolarised first wavelength; the second light being one of: a second polarisation at a second wavelength; the single wavelength having a second polarisation; or an unpolarised second wavelength; providing a first detector adapted to the receive first scattered light from a particle(s) in the detection zone in response to the first light and in response to a fluid flow containing particle(s) in the detection zone; providing a second detector adapted to the receive second scattered light off a particle in the detection zone in response to the second light and also in response to the fluid flow containing particle(s) in the detection zone; by using the output of the first detector and/or the second detector, determining the size or range of sizes of at least one particle in the fluid sample based on at least intensity of the first scattered light and/or intensity of the second scattered light at a refractive index or a range of refractive indices.

The intensity of the first and second scattered light may be used.

The determination may be displayed, such as to represent the number of particles counted at each refractive index and/or particle size.

According to a tenth aspect of the disclosure, there is provided a detector adapted to operate in accordance with the method of any one of aspects of the disclosure.

A particle detection zone adapted for use with a particle detector for detecting the size or range of sizes of at least one particle in a fluid sample, the detection zone comprising: a disposable outlet filter capsule incorporating a transparent spherical region forming a chamber and adapted, in association with the particle detector, to be located proximate an area of laser focus, the chamber forming the zone in which particles are impinged with light from the laser and from which light scattered in response to the presence of particles can be emitted so as to obtain signals for processing by the particle detector.

Aspects provided by the present disclosure comprise at least some of the following:

reliable, very-early warning of an overheating, pyrolysis or fire event minimising unwanted alarms caused by dust or steam (water vapour);

ability to discriminate against a certain particle size range or ranges, so as to alleviate false alarms from dust or steam, allowing higher sensitivity settings, for earlier warning of a pyrolysis event;

ability to monitor aerosol particle size accurately, independent of particle surface chemistry and morphology, which affects brightness of light reflection/scattering/absorption (for example, monodisperse polystyrene spheres, salt crystals, diamond powder or carbon granules have been used for calibration, having widely differing refractive indices, light absorption and reflectivity at the same size).

ability to monitor aerosol particle size as well as aerosol density (concentration) simultaneously;

ability to overcome uncertainty caused by unknown levels of smoke density dilution (caused by mixing with ambient fresh air), because the particle size is unchanged by said dilution;

ability to detect light scattered at different wavelengths at approximately the same light-scattering angle or range of angles;

ability to measure the same single particle at two different wavelengths or polarisations relatively simultaneously—overcoming the unreliable process of the prior art using particle brightness to infer particle size;

ability to measure the same cluster of particles at two different wavelengths or polarisations relatively simultaneously;

ability more-accurately to monitor change in aerosol particle size over time, permitting improved fire signature (profile) identification/recognition;

ability more-accurately to monitor rate of change in aerosol particle size (acceleration);

ability to assess the level of fire risk based on the smoke species, smoke density and particle size;

ability to assess the level of fire risk based on the rate of change in the smoke density and particle size;

ability to provide some commonality in the manufacture of a device to operate either as a particle counter or as a nephelometer by the exchange of a lens (for example to suit requirements of the air pollution market or fire safety market respectively);

avoids uncertainty in particle size measurement (in known particle counters) caused by differing rates of airflow, affecting “period of view” (the time for which a particle remains in view);

ability to select differing polarisations of light scattered towards each receiver, by rotation of the laser in relation to the receivers, in order to improve performance;

simplified focusing by use of a single wavelength of light;

with less concern for laser instability with use of a single wavelength of light;

reduced cost with use of a single wavelength of light;

reduced complexity with use of a single wavelength of light;

increased signal to noise ratio (SNR) with use of a single wavelength of light;

reduced power drain with use of a single light source;

ability to position receivers to compare the forward, side and/or backward scatter levels at one or both wavelengths and polarisations, to enhance large-particle differentiation and sizing;

a relatively compact instrument, thereby reducing cost in design and construction, and facilitating the construction of a portable instrument;

a relatively non-critical chamber geometry and relatively non-critical placement of chamber components (due to tight control of focusing available from a laser beam because of coherence);

relatively resistant to soiling which could cause loss of sensitivity or accuracy over time (achieved by the ability for a direct and unobstructed laminar air flow through the chamber at low Reynolds Number);

reduced need for a dust filter which can be unreliable due to filter loading over time and due to the partial removal of smoke (reducing the smoke sensitivity of the instrument);

no need for a mirror (a concentrating reflective surface) to concentrate the scattered light, which could lose sensitivity and accuracy due to mirror soiling;

improved particle(s) size determination;

improved particle(s) refractive index determination;

improved particle detection by use of parallel beams, two polarisations, and, for instance, a single light source;

use of refractive index to assist in identifying type or species of aerosol;

alternative physical receiver placement, two sets of receivers, and set at an angle to the light beam;

two wavelength excitation arrangements offer enhanced discrimination and identification amongst particulate species;

embodiments disclosed herein offer significantly better aerosol species identification compared with prior art solutions;

better noise performance

simpler and less expensive particle species identification device compared with prior art solutions; and

identification of SARS-CoV-2 indicative particle(s) or other microbial and pathogenic species.

Further scope of applicability of embodiments of the present disclosure will become apparent from the detailed description given hereinafter. However, it should be understood that the detailed description and specific examples, while indicating certain embodiments of the disclosure, are given by way of illustration only, since various changes and modifications within the spirit and scope of the disclosure herein will become apparent to those skilled in the art from this detailed description.

### BRIEF DESCRIPTION OF THE FIGURES

Further disclosure, objects and aspects of other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates light scattering vs particle size at different wavelengths such as green and infrared;

FIG. 2 illustrates the Quotient of the received green signal to the received infrared signal;

FIG. 3 illustrates Figure of Merit to determine Particle Size;

FIG. 4 illustrates a schematic diagram of one form of the disclosure (elevation view);

FIG. 5 illustrates a schematic diagram of another form of the disclosure (plan view);

FIG. 6 illustrates a schematic diagram of yet another form of the disclosure (plan view);

FIG. 7 illustrates Test results for various aerosol types;

FIG. 8 illustrates Test results converted to particle size;

FIG. 9 illustrates Test results converted to Risk factor;

FIG. 10 illustrates Test results converted to Acceleration;

FIG. 11 illustrates an embodiment of a method of determining particle size, and optionally refractive index;

FIG. 12 illustrates a pulse waveform (in schematic format) as a particle passes through the laser beam configured as a particle counter;

FIG. 13 illustrates an example data table (portion thereof);

FIG. 14 illustrates a further embodiment of a method of determining particle size, and optionally refractive index, velocity and optionally with temperature correction;

FIG. 14A illustrates a further embodiment of a method of determining particle size, and optionally refractive index, velocity and optionally with temperature correction using a light source comprising a single wavelength;

FIG. 15 illustrates light scattering vs particle size at two different wavelengths at four different refractive indices (log-log scale), compared with some example particle sizes for virus, and mean sizes for typical smokes and dust;

FIG. 16 illustrates light scattering intensity vs particle size at two different wavelengths with normal (i.e. perpendicular) polarisations, each at four different refractive indices (log-linear scale);

FIG. 17 illustrates a Quotient of green signal to infrared signal with normal polarisations at four different refractive indices (log-linear scale), compared with some example particle sizes for virus, and mean sizes for typical smokes and dust;

FIG. 18 illustrates readings of wavelength and refractive index for some (example only) aerosols;

FIG. 19 illustrates two elevation cross-sections of one form of the disclosure configured as a nephelometer including light ray tracings and indicating receiver positions and a nozzle position for introducing air to be monitored;

FIG. 20 illustrates two elevation cross-sections of another form of the disclosure configured as a particle counter including light ray tracings and indicating receiver positions and a nozzle position for introducing air to be monitored;

FIG. 21 illustrates two elevation cross-sections of another form of the disclosure configured as both a particle counter and a nephelometer including light ray tracings and indicating receiver positions and a nozzle position for introducing air to be monitored;

FIG. 22 illustrates a schematic diagram of an air flow configuration including an aspirator (pump) for monitoring an aspirated aerosol when connected to an external sampling pipe;

FIG. 23 illustrates a cross-sectional view of a hand-held breathalyser embodiment in accordance with an aspect of disclosure with replaceable mouthpiece and replaceable outlet filter and in which air flow streamlines are shown passing through the laser focus as they cross the chamber vertically downward;

FIG. 24 illustrates a Signal Processing Schematic of one embodiment of the present disclosure;

FIG. 25 illustrates in cross-sectional view, a hand-held breathalyser second embodiment in accordance with an aspect of the disclosure;

FIG. 26 illustrates a dual polarisation configuration 2600 of a detector according to the present disclosure;

FIG. 27 illustrates results from numerous and different example quotients calculations;

FIG. 28 illustrates results from the quotients of (ΨGN+IRN)/IRN;

FIG. 29 illustrates results from the quotients of (ΨGN+IRP)/IRP;

FIG. 30 illustrates the results of using only a single wavelength, taking the quotients of Green Normal and Green Parallel (GN/GP), at the various refractive indices;

FIG. 31 illustrates the results of using only a single wavelength, taking the quotients of Green Normal and Green Parallel (GN/GP), assuming negative refractive index of the scattering particles;

FIG. 32 illustrates scattered light intensity and light scattering at various refractive indices at 532 nm;

FIG. 33 illustrates scattered light intensity and light scattering from particles with a negative refractive index compared with scattering from water;

FIG. 34 illustrates a quotient GN/GP and particle sizing at 532 nm;

FIG. 35 illustrates an example data table (portion thereof) but related to the GN/GP quotient;

FIG. 36 illustrates a Dual Polarisation method of Particle Classification in accordance with yet another aspect of disclosure;

FIG. 37 illustrates specific particle counts at various refractive indicies;

FIG. 38 illustrates Dual Wavelength method of Particle Classification in accordance with yet another aspect of disclosure;

FIG. 39 illustrates a further configuration 3900 of a detector according to the present disclosure; and

FIG. 40 illustrates a further configuration 4000 of a detector according to the present disclosure.

### DETAILED DESCRIPTION

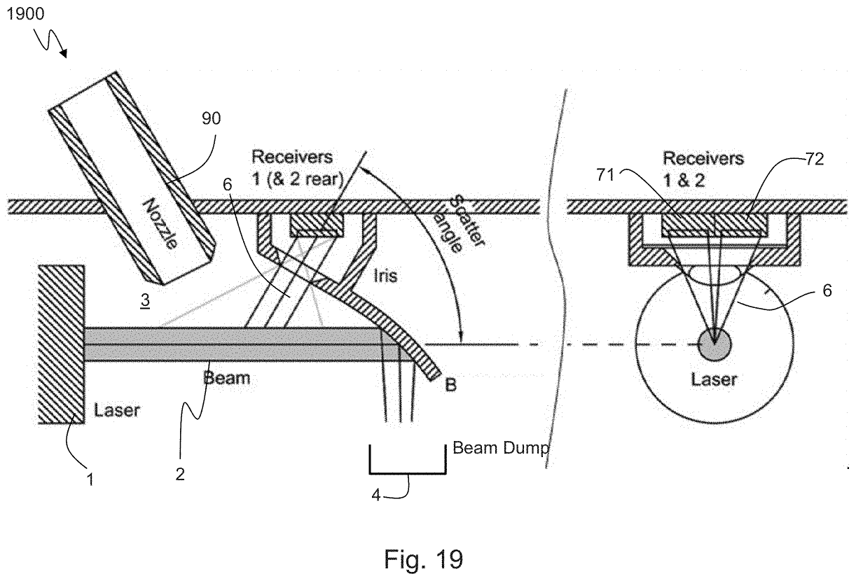

For purposes of description herein, the terms “upper”, “lower”, “right”, “left”, “rear”, “front”, “vertical”, “horizontal”, “interior”, “exterior”, and derivatives thereof shall relate to the disclosure as oriented in FIGS. 19, 20 and 21. However, it is to be understood that the disclosure may assume various alternative orientations, except where expressly specified to the contrary. It is also to be understood that the specific devices and processes illustrated in the attached drawings and described in the following specification are simply exemplary embodiments of the inventive concepts defined. Hence, specific dimensions and other physical characteristics relating to the embodiments disclosed herein are not to be considered as limiting. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

In an embodiment of the disclosure, optical output from a laser source, such as a single laser source, producing both visible and infrared light, is directed through an optical chamber or housing. The chamber may be light-tight against unwanted external light sources such as ambient lighting including transient scattered sunlight. The chamber also contains two receivers positioned to detect light scattered in a predetermined direction or range of directions, off aerosol particles that may pass through the light path in the chamber. The range of directions may typically embrace from 20° to 90° to the laser light path axis.

As would be known to those skilled in the art, it is also possible to obtain a single light source by combining at least two laser beams (not shown). In this instance, the first and second laser beams are placed at 90° to each other, such that their beams meet. At this point of intersection, a dichroic filter is placed at 45° to each beam. The first beam substantially passes straight through the filter, while the second beam is substantially reflected off the face of the dichroic filter, having a 45° angle of incidence and a 45° angle of reflection, such that it becomes relatively aligned with the first beam. By intention the combined beams are substantially parallel and concentric. The combined beams are subsequently presented to an achromatic lens to focus the two beams to form either a common parallel beam for a nephelometer, or a common focus spot for a particle counter.

The ability to determine the presence, size and refractive index of particles(s) could be achieved using two separate light sources or lasers. The single-laser arrangement is useful because the instrument can be more compact, the power consumption is substantially lower, the cost is reduced, and also because variations in the laser power (i.e. stability) at each wavelength tend to track each-other, such that the quotient calculation (as disclosed herein—see Equations 9 or 10) is relatively unaffected by the variations of fluctuations of the laser output power.

The magnitude and direction of light photons that are scattered off aerosol particles has been determined in the present disclosure by application of the Mie-scattering equations of Gustav Mie—more specifically the light intensity scattering matrix using the parameters of George Stokes relating to light polarisation. (Gustav Mie (1868-1957) and George Stokes (1819-1903) are physicists who are considered to be readily found on Google/Wikipedia).

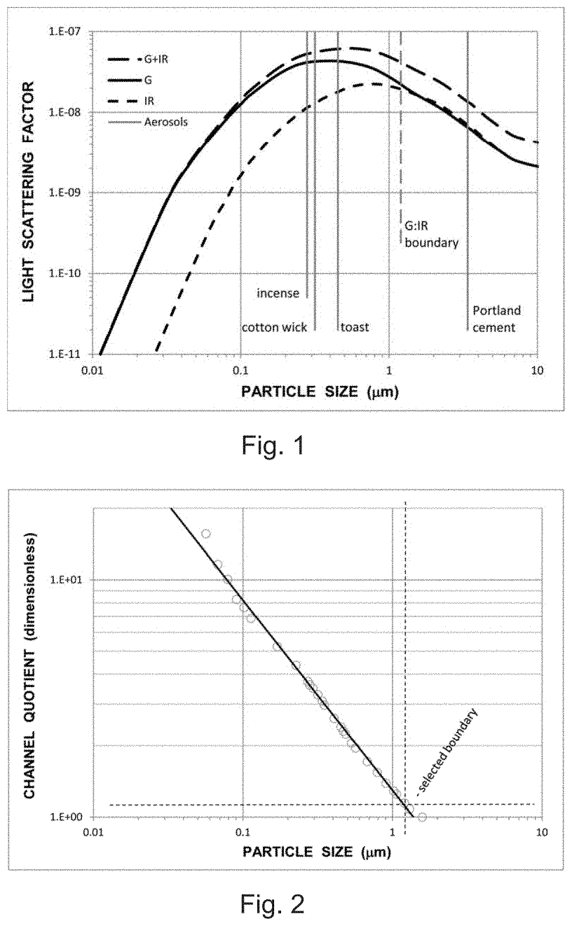

FIG. 1 charts the intensity of light scattered off particles ranging in size from 0.01 to 10 microns (log-log scale), at wavelengths of approximately 532 nm (green) and approximately 1064 nm (infrared), said particles having a refractive index of approximately 1.5. This particle size range embraces smoke typified by the known mean size of smouldering incense, smouldering cotton wick and burning toast smoke, as well as dust typified by the mean size of Portland cement particles (a considered standard dust surrogate).

In FIG. 1, the upper (long dash G+IR) curve represents the light detectable by a green+infrared light receiver. The lower (shorter dash IR) curve represents the light detectable by an infrared-only receiver. The middle (solid line G) curve represents the light detectable by a green-only receiver (if available, but otherwise obtained by subtraction of the infrared signal IR from the green+infrared signal G+IR).

The relative magnitudes of the three curves in FIG. 1 have been calibrated such that the green and infrared curves coincide as closely as possible, for all particles larger than a selected G-IR boundary. In FIG. 1 this boundary is indicated by the vertical dashed line: G:IR boundary, which is typically set to about 1.2 micron. This is the notional boundary between smoke and dust.

In a practical embodiment of the disclosure, by using two said receivers, light scattered off aerosol particles produces a first channel signal and a second channel signal. Inherent in each signal is a steady offset component produced by background reflections in the said optical chamber. This offset may be zero, but it is nevertheless accounted for.

FIG. 2 presents the relative magnitude of the green signal compared with the infrared signal, in a mathematically-desirable dimensionless form, as a quotient of the light scattering (log-log chart). It can be seen that for all particles smaller than the boundary value, the green (˜532 nm) signal is significantly greater than the infrared (˜1064 nm) signal.

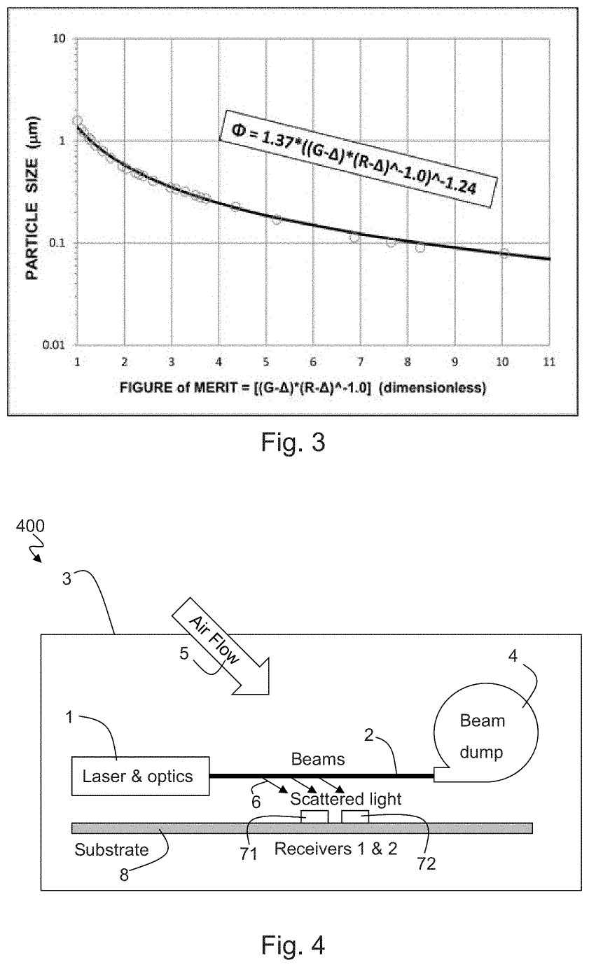

FIG. 3 presents a convenient Figure of Merit which is a dimensionless coefficient that enables the particle size to be deduced directly from the relative green (˜532 nm) and infrared (˜1064 nm) signal levels. The curve of best fit to these data, for scattering quotient values below the selected boundary, is given by an equation of the form:

Ψ_{GR}=Ω*((G−Δ_{G})*(R−Δ_{R})^{-1.0})^{-Γ} (μm) [Equation 1]

where:

Φ_{GR} is the particle size (μm) in view at any given moment in time;

is a coefficient such as, in a particular embodiment, for example 1.37;

is a coefficient such as, in a particular embodiment, for example 1.24;

G is the green signal level;

R is the infrared signal level; and

Δ_{G} and Δ_{R} are the offset values for each channel which are generally adjusted to have the same value.

Accordingly, it is made possible to produce a device for the detection of aerosol particles, wherein the particle size can be determined (typically expressed in microns). Because small particle sizes generally imply more-complete combustion or higher combustion temperatures, said particle size value (the number of particles of a predetermined size detected) may indicate the level of risk associated with a given fire incident.

It is noted that most smoke detectors respond to the optical density of smoke aerosol present (typically expressed in %/m obscuration). In the present disclosure, the inventor has realised that the optical smoke density (independent of particle size) is available by subtraction of the magnitude of the infrared signal (regarded as a reference signal), from the green signal. However, the available smoke is often diluted by ambient fresh air, especially if the smoke detector is at some distance from the smoke source, so smoke density alone does not necessarily indicate the level of fire danger accurately.

In one embodiment of the current disclosure, the smoke density value is combined with the particle size value to produce a new value representing the level of risk. In one particular embodiment of this disclosure, the level of risk is obtained from the quotient of the smoke density and the particle size with an equation of the form:

Θ_{GR}=K_{Θ}*(((G−Δ_{G})−(R−Δ_{R}))/(Φ_{BR}))^{0.5} [Equation 2]

where:

Θ_{GR} is the risk factor;

K_{Θ} is a constant of scaling; and

G, R, Δ_{G}, Δ_{R}, and Φ_{GR} are as previously defined in Equation 1.

In yet a further embodiment of the disclosure, the data produced may be logged and analysed over time, to determine the rate of change in smoke density and particle size. The risk factor output level is adjusted according to the rate of acceleration of the pyrolysis event, with an equation of the form:

Ψ_{G}=K_{Ψ}*dΘ_{GR}/dt [Equation 3]

which is a differential equation where:

Ψ_{G} is the risk acceleration factor (change in risk vs time), which may for example range below unity for slow, smouldering fires, or above unity for fast flaming fires.

K_{Ψ} is a constant of scaling.

Additionally, it is possible to provide an output responsive only to smoke, and another output responsive only to dust. In this way, an embodiment of the present disclosure can be set with very high sensitivity in order to provide the earliest warning of an overheating, smouldering, pyrolysis or fire event without false alarms due to dust or steam aerosols. While in addition, it separately provides an output responsive to dust levels for the purpose of health hazard or maintenance warnings.

Benefits similar to all of the above could be achieved using an infrared laser of 946 nm and a BIBO (bismuth triborate) crystal to produce a blue laser of 473 nm for example. Then, the B:IR boundary (of FIG. 1) would typically be set for a particle size of 1.0 μm (not shown), which is regarded as slightly better than the 1.2 μm typically used here. In this case the calculation for particle size has been determined with an equation of the form:

Φ_{BR}=Ω*((B−Δ_{B})*(R−Δ_{R})^{-1.0})^{-Γ} (μm) [Equation 4]

where:

Φ_{BR} is the particle size (μm) in view at any given moment in time;

is a coefficient such as, in a particular embodiment, for example 1.11;

is a coefficient such as, in a particular embodiment, for example 1.12;

G is the green signal level;

R is the infrared signal level; and

Δ_{B} and Δ_{R} are the offset values for each channel which are generally adjusted to have the same value.

In one embodiment of the present disclosure, the smoke density value is combined with the particle size value to produce a new value representing an arbitrary level of risk. In one particular embodiment of this disclosure, the level of risk is obtained from the quotient of the smoke density and the particle size with an equation of the form:

Θ_{BR}=K_{Θ}*(((B−Δ_{B})−(R-Δ_{R}))/(Φ_{BR}))^{0.5} [Equation 5]

where:

Θ_{BR} is the risk factor for blue light;

K_{Θ} is a constant of scaling;

B is the Blue signal level; and

R, Δ_{B}, Δ_{R}, and Φ_{BR} are as previously defined in Equation 4 above.

In yet a further embodiment of the disclosure, the data produced may be logged and analysed over time, to determine the rate of change in smoke density and particle size. The risk factor output level is adjusted according to the rate of acceleration of the pyrolysis event, with an equation of the form:

Ψ_{B}=K_{Ψ}*dΣ_{BR}/dt [Equation 6]

which is a differential equation where:

Ψ_{B} is the risk acceleration factor (change in risk vs time) for blue light, which may for example range below unity for slow, smouldering fires, or above unity for fast flaming fires.

K_{Ψ} is a constant of scaling.

However, the blue laser combination is considered generally less efficient, has a lower temperature tolerance and would also need to be specially made, whereas the green laser combination is relatively widely available and inexpensive.

In one embodiment of the disclosure, the device is configured as a nephelometer rather than a particle counter. A nephelometer responds to the cloud density—using the bulk scattering of light off a large number of particles—and takes an average reading of all the particles in view. Accordingly, for this embodiment, the laser is collimated to a parallel beam (such as about 2-3 mm diameter) and provides a cylindrical scattering volume.

In another embodiment of the disclosure, the device is configured as a particle counter. This is achieved by simple modification of the beam focusing within the laser optics. Accordingly, by the inclusion or omission of one or more lens, the device of the present disclosure could be configured as either a nephelometer or a particle counter. The laser outlet (aperture) may be about 2-3 mm diameter. There is a lens at the outlet of the laser that either collimates the beam for a nephelometer, or instead focuses the bean to a spot, such as 4 to 12 mm beyond the lens, for a particle counter.

Configured as a particle counter, the disclosure responds to the light scattered off one individual particle at a time, requiring the laser to be focussed to a tiny spot, for instance, small enough to contain only said one particle at a time (said spot being typically on the order of one micron diameter). The prior art for particle counting, using a single wavelength laser, offers some degree of particle size measurement, according to the brightness of the light scattered. However, this prior art process is not considered reliable because it is subject to the albedo of the particle which may vary due to shape, refractive index or chemistry. Moreover, it is possible for two or more tiny particles to be in view together. Alternatively, it is possible for a large particle to be only partially in view. In these cases, the particle size is considered to be misrepresented by the brightness level received. Moreover, it is common for particle counters of the prior art to become saturated if the cloud density is very high.

In contrast, in the present disclosure, the use of two wavelengths projected from a common source is considered to provide a more reliable means for measurement of particle size in a particle counter, alleviating some of the uncertainty that the same particle is exposed to each wavelength at the same moment of measurement as may occur in prior art arrangements. As a result of having more certainty of the particle size, it is possible to accrue results for use in particle counting by recording, ‘binning’ or counting the number of particles of a corresponding size. Typically, the particles will be ‘binned’ or sorted into a selected and/or predetermined range of particle size(s), such as very small, small, large, very large, smoke and/or dust or steam, or according to a sizing selected by the user. Particles can be sized in various ways as listed earlier. In the present embodiment, optical sizing is used, which relates directly to the wavelengths of light in use. As such, the sizing can be as relatively precise as the wavelengths are, relating back to Mie Theory of light scattering. It is considered that the embodiment should be able to distinguish smoke from nuisance aerosols. Beyond that, the population of particles (in a polydisperse cloud) produced at any given stage of a pyrolysis event will typically range in size according to a Gaussian statistical distribution. So, the mean size (or nominal size) is considered. Dust particles are much less predictable according to the multitude of possible sources, including fine sand, pulverised coral, pulverised limestone, pulverised coal, rubber from tyres, pollens, fibres (synthetic or natural), asbestos, volcanic dust, micro-meteorites, etc.

In either the nephelometer embodiment or the particle-counting embodiment of this disclosure, the laser may be pulsed in order to conserve energy and reduce temperature rise, and to improve the signal-to-noise ratio of the signals. This is considered to reduce current drain (energy saving, especially when operating from a battery in the event of mains failure) and for reducing heat build-up in the laser, especially at high ambient temperatures, and even for laser longevity. In an embodiment, a 10% duty cycle maybe used as an example, synchronously gating the receivers for best signal-to-noise ratio.

In an embodiment of the disclosure, and with reference to FIG. 4, the detector 400 comprises a visible+infrared laser 1 producing a coaxial pair of collimated beams 2 within an opaque chamber 3. The opaque chamber 3 prevents interference from ambient light, especially transient ambient light (not shown). At the far end of the chamber, a beam dump 4 absorbs the remnant laser energy. Gaseous medium 5 such as air that may contain aerosol particles is constrained to flow through the laser beam. A small proportion of the laser light of beams 2 is scattered in all directions forming scattered light 6, off the particles as they pass through the beam 2. Some of this scattered light 6 falls upon the receivers 71 and 72, said receivers being typically mounted on a common substrate 8 such as a printed circuit board (pcb). The need for optical enhancement, such as receiver focussing lens(es) or iris(es) used in the prior art, can be avoided.

This scattered light 6 is typically many orders of magnitude weaker than the incident laser light 2, so it is critical to avoid swamping the scattered light 6. The tight beam control provided by a laser light source 1 makes this possible, using comparatively minimal precautions in the design of the chamber. The same tight beam control makes it possible to locate two receivers 71 and 72 relatively close to each other rather than being co-located (as is done in prior art arrangements), in order to obtain reliably comparable signals from each receiver 71 and 72.

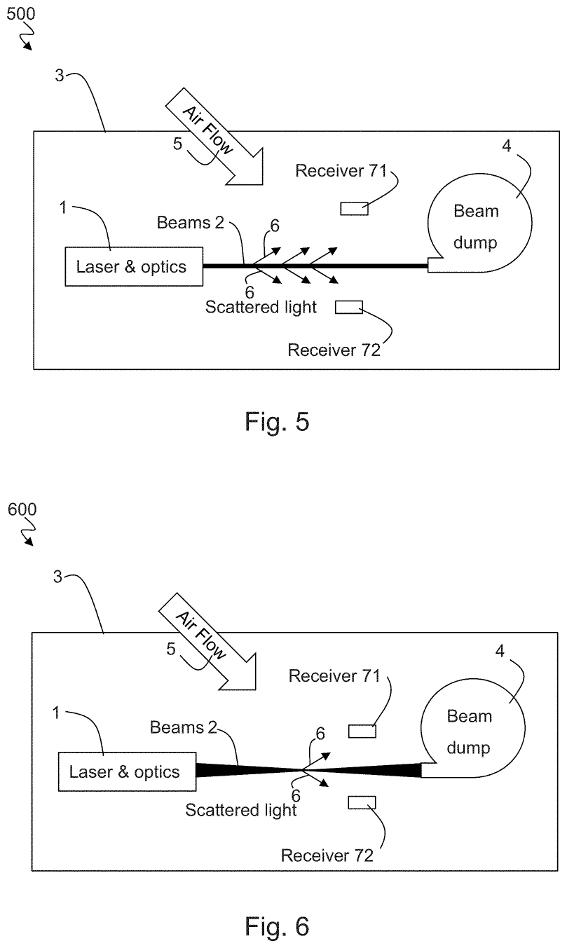

The impinging air flow (that may contain smoke and/or dust) may be set to a low velocity. The simplicity of the physical design of further arrangements of detector 100, detectors 400 and 500 respectively as illustrated in FIGS. 4 and 5, and the low velocity of the impinging air flow, serve to minimise soiling that could otherwise be caused by dust settling-out from said air flow. In other words, designing for a low Reynolds Number, thereby determining a laminar flow regime, facilitates particles to remain substantially entrained within the flow. This dust-avoidance technique assists in maintaining the calibration and sensitivity of the detector in the long term, such as 10 years. This longevity is achieved without need for dust filtration and the attendant maintenance regimen.

In some embodiments, two receivers are positioned relatively side-by-side, either longitudinally as in FIG. 4, or laterally as receivers 71 and 72 in FIG. 5, with respect to the coaxial laser beams.

The coaxial laser beams, in one embodiment, may be polarised. A pre-set rotation of the laser with respect to the receivers may be used to optimise the detection performance. Accordingly, in one embodiment of the disclosure, and as illustrated in FIG. 5, the receivers 71 and 72 are mounted on either side of the laser beam 2 while subtending a radial angle of substantially +45° and −45° respectively to the laser centre 1. The laser rotation is set such that one receiver is aligned with horizontal polarisation while the other is aligned with vertical polarisation. Using horizontal polarisation for the longer wavelength light, together with vertical polarisation for the shorter wavelength light, has been determined mathematically to produce an improved signal-to-noise ratio.

FIG. 6 illustrates a particle counter embodiment of the present disclosure, in which laser light of two wavelengths is focused to an area corresponding to size small enough for one particle at a time to be discerned and/or measured as it passes through the area.

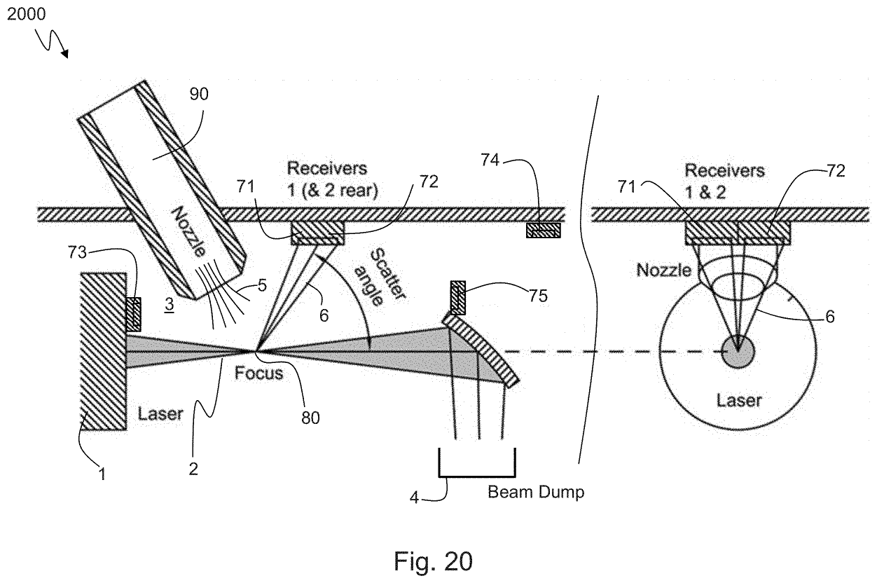

It is known from Mie light-scattering theory that the intensity of light scattered in any given direction, is determined by the particle size in a predictable way. Especially so for particles larger than the wavelength of light. Typically, the scattered light intensity is brighter in the forward-scattering region, less bright in the backward-scattering region, and greatly reduced at right-angles to the laser beam. This offers an opportunity to further refine the particle size measurement. Multiple receivers 71, 72 and or other receivers (not shown) could be placed at differing polarisations and scattering angles to the axis of the beam 2, to enhance the ability to determine particle sizes, especially for large particles, in order to characterise dust types. Therefore, in one embodiment of the disclosure, whether configured as a nephelometer or as a particle counter, an additional receiver (not shown) is set at a relatively small angle to the laser axis, such as 10°, for example one or more of receivers 73, 74 or 75 of FIG. 20. Data from this receiver is compared with data from another receiver such as receiver 71 or receiver 72 in FIG. 5. This data comparison is used to refine the detection of dust.

For the detection of smoke, blue light may be preferable to other colours because of its short wavelength for detecting small particles, when used in combination with an available PIN photodiode receiver which has sufficient sensitivity at that wavelength. Violet and ultraviolet colours would provide even better sensitivity to the smallest particles, but sufficiently sensitive receivers are not generally available at such short wavelengths. Moreover, the pre-set boundary could begin to encroach on the largest smoke particles.

Test Results

Testing of one embodiment of the disclosure has been conducted, with the following typical results using blue 470 nm and infrared 940 nm light.

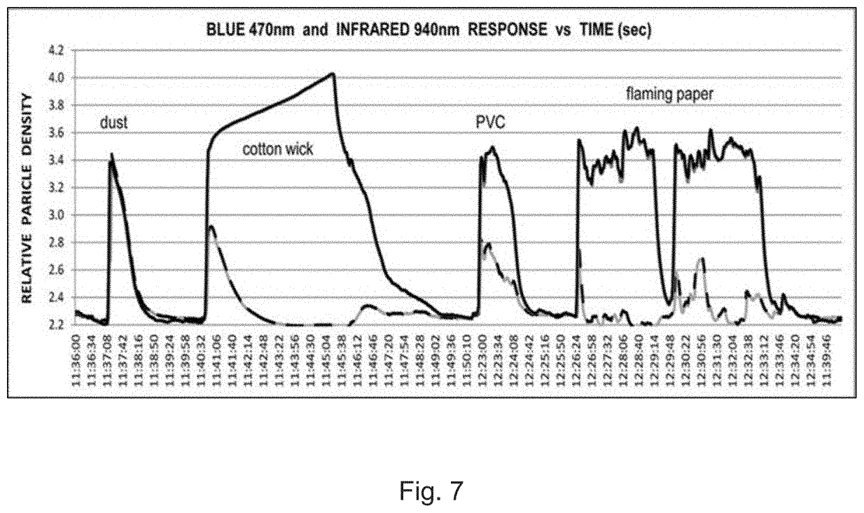

In FIG. 7, note the significant differences in the response to smoke by blue light (solid line) and infrared light (dashed line), indicating that long wavelength light does a poor job in detecting smoke compared with short wavelength light. However, there is an equal response to dust at both wavelengths.

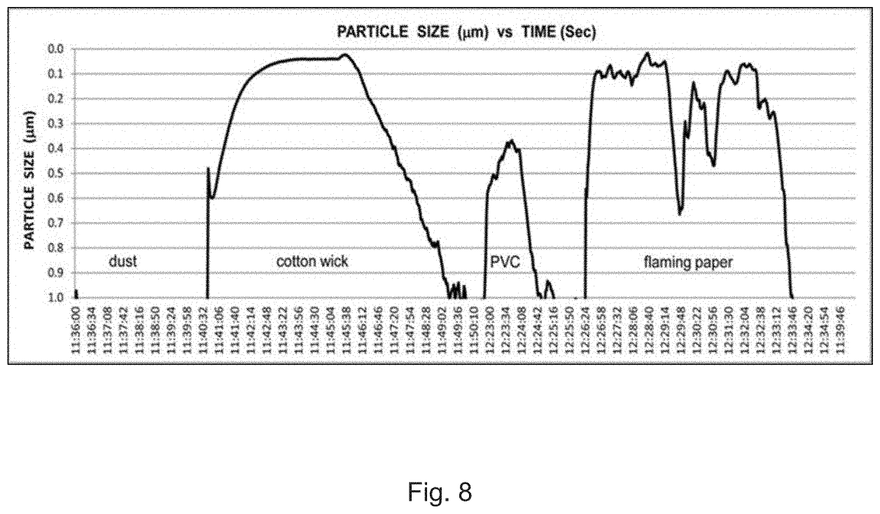

In FIG. 8, the data of FIG. 7 has been computed according to Equation 4, to provide the particle size. Here we note that the nuisance dust aerosol has been desirably ignored while the smoke aerosol particle sizes are clearly discerned. This chart also demonstrates that following ignition, smaller particles are soon produced as the rate of combustion increases. Then as each fuel becomes exhausted, the rate of combustion falls and the particle size increases.

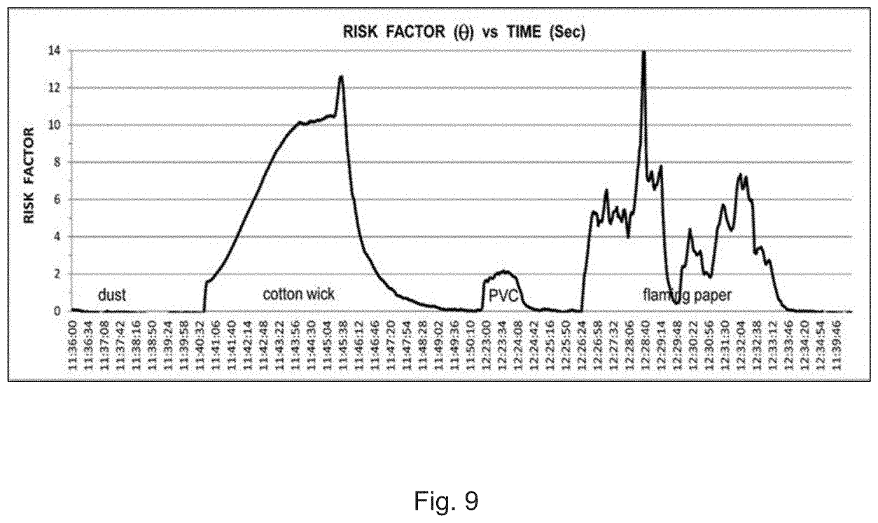

In FIG. 9 we see that the particle size data (of FIG. 8) augmented by the optical density data (of FIG. 6) in accordance with Equation 5, produces the risk profile which varies according to the rate of combustion. A smouldering source is identified of lower risk than a flaming source.

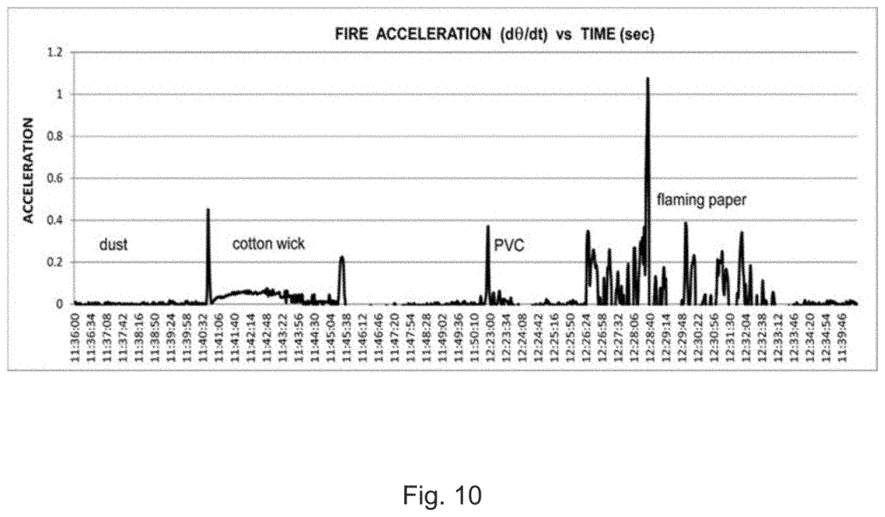

With reference to FIG. 10, the test results of FIG. 9 are converted to Acceleration (rate-of-change of risk) in accordance with Equation 6. By contrast the high relative acceleration for the flaming paper indicates the relative rapid evolution of this event. These results show a relative measure which may be useful to a user and/or system that is monitoring an evolving fire situation.

### Second Embodiment

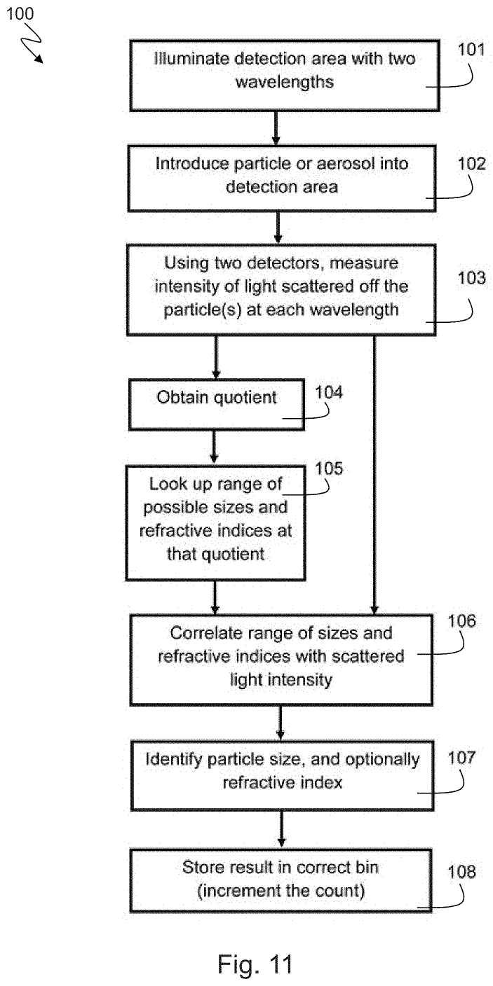

As a general outline of the approach taken in another aspect of the disclosure as disclosed herein, and with the assistance of the exemplification of a method 100 as illustrated in FIG. 11 and according to an aspect of the disclosure, the inventor has realised that illuminating a detection area 101 with two separate wavelengths, for instance, from a single source can be used to scatter light from various aerosols/particles passing through 102 the path of light. As noted above, as an alternative arrangement, the two wavelengths may be provided by at least two lights sources. It is possible to select either parallel or normal polarisation for either or both wavelengths. Each particle has a size and a refractive index, determined by its chemistry. At a given wavelength and polarisation, both the size and the refractive index together determine the magnitude and directions in which the incident light is scattered 103. In sampling a random aerosol, there is little, if any information about the refractive index to choose, so the inventor has realised a process that utilises both the amplitude and quotient to resolve the ambiguities in both size and refractive index.

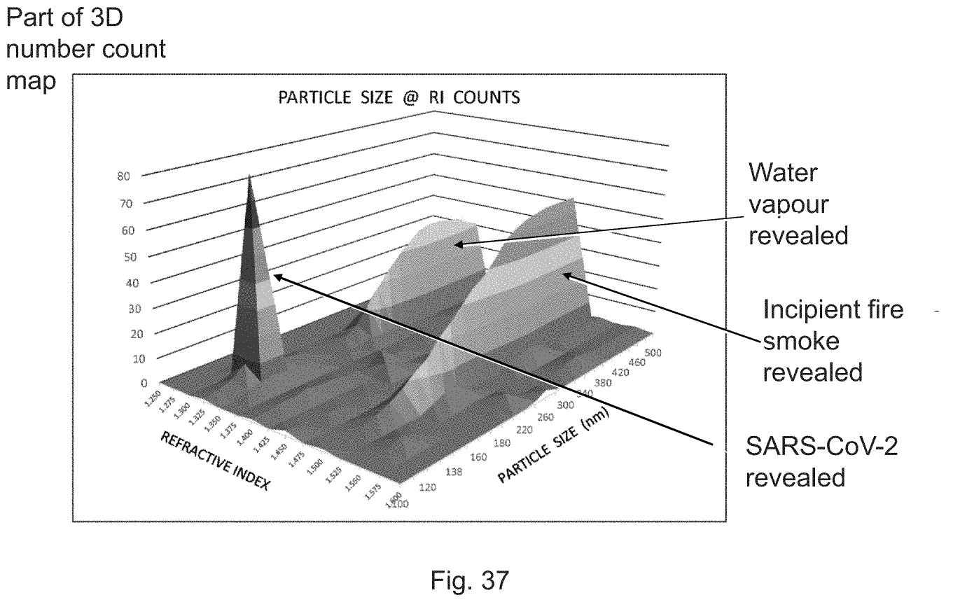

Particle characterisation using the dual wavelength or polarisation systems and methods disclosed herein involves the size, refractive index and any changes over time. In the case of a particle counter, detected scattered signals accumulate this information in the form of “bins” i.e. by grouping the received scattered signals according to a determination of the particle size range and refractive index range determined from the detected signals. The number and sizing of bins assigned in any given embodiment of the disclosure is chosen to suit the application and/or the type and composition of particles being detected. FIG. 37 illustrates specific particle counts at various refractive indicies. For example, and with reference to FIG. 37, in searching for SARS-CoV-2 particles specifically, a particular bin may be assigned for particles having a size in the range of between about 133 to 143 nm diameter and having a refractive index in the range of between about 1.32 to 1.34. These could be distinguished from other common virus particles by variations in the particle size and or refractive index, for instance, examples of other virus sizes include HIV at about 120 nm diameter, T4 Bacteriophage at about 225 nm diameter and Mimi virus at about 400 nm diameter. FIG. 37 also illustrates, for example, water vapour and smoke particles being identified. If, for example, there was also a bin for particles with a diameter of 133 to 143 nm diameter and 1.70 to 1.72 refractive index, this would not represent SARS-CoV-2. Thus, the detected signals can be plotted in a 3D array of bins and/or recorded in a 3D matrix cell array. As each particle is measured, the result is used to increment the correct bin or matrix cell count. After a significant time period, such as one second, several of the bins or cells may accumulate counts indicating a higher concentration of particles with that diameter and refractive index combination. The pattern of bin or cell counts is thus used to characterise the aerosol by inspection of count peaks in the 3D bin or matrix array. For example, if the SARS-CoV-2 bin count is significantly larger than certain other bins or cells, it may be inferred that a significant number of SARS-CoV-2 particles are present, and a positive indication of the presence of SARS-Cov-2 particles is reported. The significance of the count in relation to other bins or cells is used to discriminate against a random background spread of particles which by chance, may happen to include a small count in the SARS-CoV-2 bin or cell. Additionally, the same or similar embodiment could be used to detect other target particles of interest, which would significantly accumulate in a different bin or cell. This might include a new strain of SARS-CoV-2, or some other virus of different size and/or RI. Different bins or cells could aggregate a predetermined broad range of different sizes, whereas some other bin or cell sizes could be very tightly constrained. Moreover, the broad spread of particle size and RI counts could be used to indicate other conditions. It will be appreciated that since the signal counts accumulated in each predetermined bin or cell are independent of other bins or cells, it may be possible to detect for two or more different types of particles simultaneously.

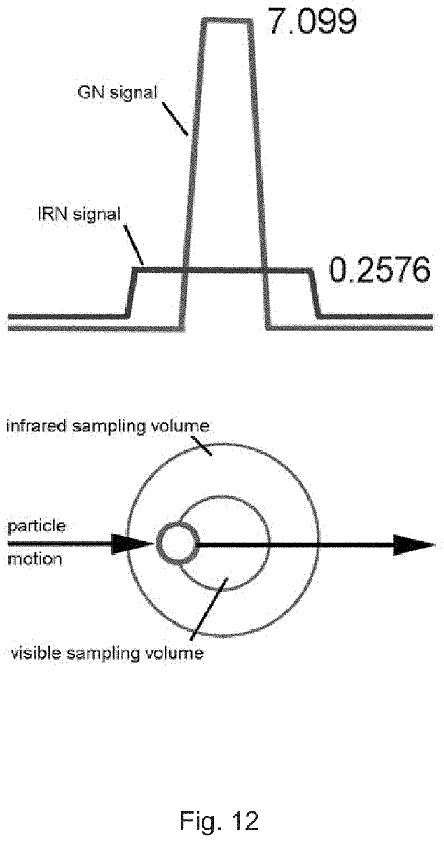

Referring again to FIG. 20, a particle in the airflow 5 passes through the laser beam 2 (sampling volume) and a portion of the laser light 6 is scattered towards the two receivers (GN and IRN) 71 and 72 and produces the pulse waveform as illustrated in FIG. 12, in which the signals received at the receivers are (green) GN=7.099×10⁻⁶ and (infrared) IRN=2.576×10⁻⁷ as an example. Obviously, the signal strength varies depending on a number of parameters as would be known to those skilled in the art.

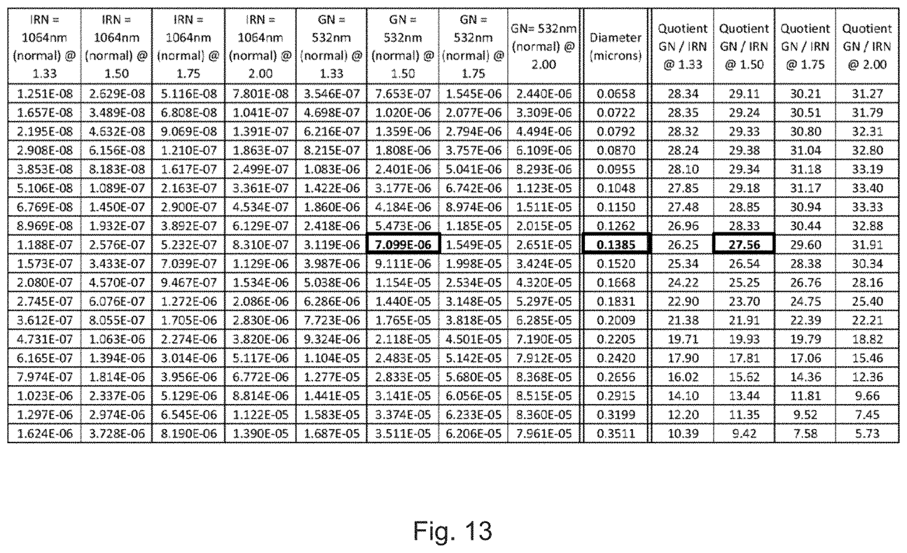

The approach may then choose a further representative range of refractive indices, dependent on the use to which the present disclosure is put, such as which particles are being sought to be detected. In one example such as that illustrated in FIG. 13, the indices may be such as, but not being limited to, 1.33, 1.50, 1.75 and 2.00. For example purposes only, 1.33 represents water vapour and is the lowest refractive index expected for some applications of the present disclosure, 1.50 is very common for smoke and dust, which generally lie within the range 1.5 to 1.6, and particles above 2.00 are not encountered often. So, in one embodiment, it is possible to interpolate between the four example indices chosen above. It is to be noted that more or fewer than four indices may be used as the application of the present disclosure applies to different situations.

In this regard, data table of FIG. 13 is not the complete data table. The complete data table is obtained from calculations using the light scattering theory of Gustav Mie. Such a complete table would reside within the microprocessor, and the numbers used in the table depend on calibration. Another point to understand, is that interpolation is used throughout the tables to discover intermediate values.

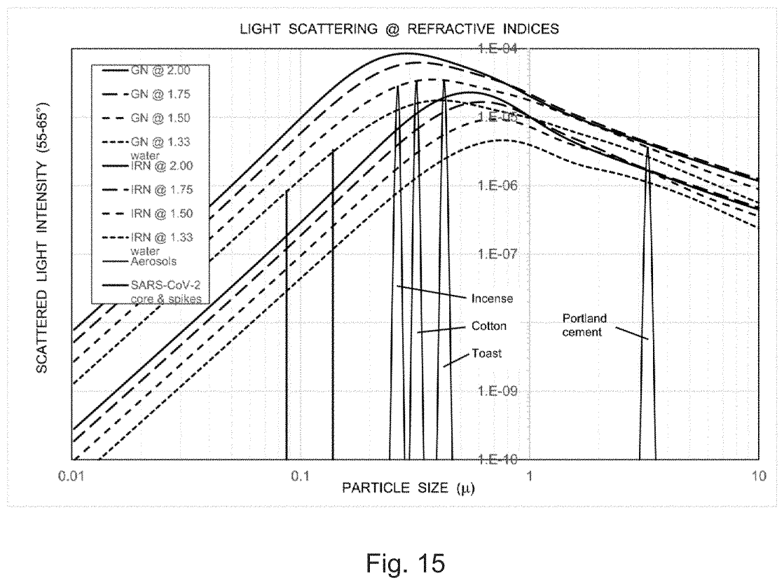

The approach, if required, may then further obtain a chart (for example FIG. 15) of a light scattering intensity 103 versus the particle size, (using the above as an example) for the four refractive indices and two wavelengths thus resulting in, for example purposes only, 8 charted curves/results. Extensive study has shown that choosing normal polarisations for each wavelength gives good results. In one example, we have selected GN (Green 532 nm Normal) and IRN (Infrared 1064 nm Normal) as the two light sources for the embodiments presented herein. This is for illustrative purposes only, other wavelengths and polarisations may be chosen as the application requires.

Depending on the particles being sought to be detected, if the amplitude of the scattered light intensity results in a difficultly in determining between possible different particle sizes, the approach may further perform a quotient 104 of the GN and IRN intensities at each refractive index. A quotient is relatively independent of possible laser light intensity fluctuations (both short term fluctuations and long-term ageing). The resultant readings have been found to improve determination of particle size, different from other particles (bearing in mind a log-log scale may be used for clarity).

Turning to the example illustrated in FIGS. 12 and 13, obtain the Quotient, Q, as:

Q=GN/IRN=7.099/0.2576=27.56

The process may test if RI=1.33. In the RI=1.33 column, the value 27.56 lies somewhere between 27.482 and 27.854. By interpolation we obtain:

(27.854−27.482)=0.372.

(27.56−27.482)=0.078

(0.078/0.378)=0.206

The corresponding diameters on FIG. 13 are 0.1048μ and 0.1150μ. By further interpolation we obtain:

(0.1150−0.1048)=0.0102

(0.0102*0.206)=0.0210

(0.0210+0.1048)=0.1258

So according to the above interpolation of FIG. 13 which was based on a refractive index (RI) of 1.33, the particle size could be 0.1258μ. For this to be true, from FIG. 13 the GN@1.33 value would have to lie within the range 1.42×10⁻⁶ to 1.86×10⁻⁶. However, the actual GN value is 7.099×10⁻⁶, so this answer is False.

The process may test if RI=1.75, then the GN @ 1.75 value would have to lie in the range 2.53×10⁻⁵ to 3.15×10⁻⁶, but this would also be False.

The process may test if RI=1.50 then the GN@ 1.50 value would have to be about 7.099×10⁻⁶, and this would be True. Therefore, we confirm that the particle size=0.138φ, and RI=1.5.

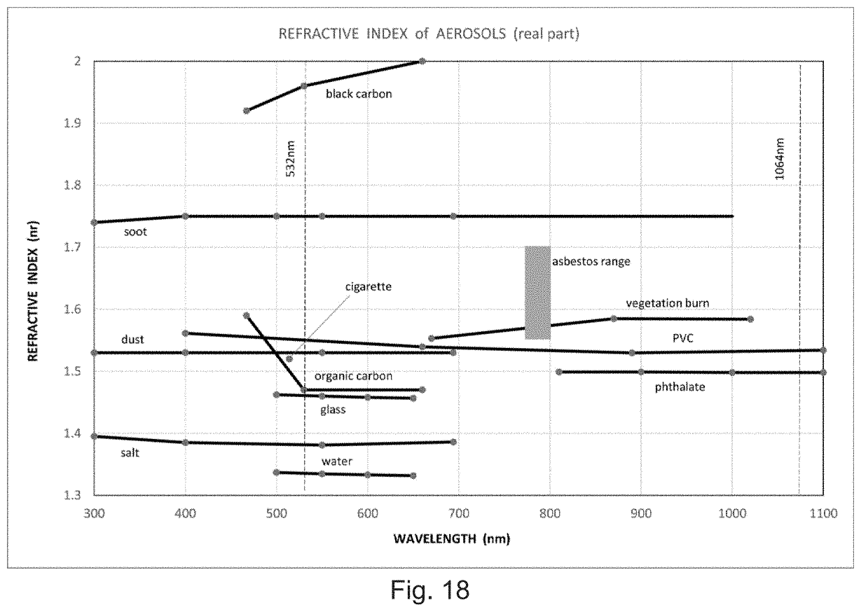

Accordingly, once the quotient 104 is determined, the particle size may lie in a range of sizes, depending on the refractive index 105. An aerosol or fluid stream may contain a large number of particles, yet when configured as a particle counter, the sampling volume is extremely small compared with this fluid stream, such that substantially only one particle is exposed to the sampling volume at any one time, so the scattered light intensity would depend on the particle size and refractive index of that particle independent of the aerosol density (here, aerosol density is defined as the number of particles per unit volume entrained within the fluid stream). Thus, light intensity and refractive index may be correlated 106 to determine a likely particle(s) size, and optionally refractive index 107. FIG. 18 illustrates example readings of wavelength and refractive index for some (example only) aerosols which may be used for the purposes of correlation in accordance with the present disclosure. The device and/or method of the present disclosure may then provide 108 a signal, notification, increment a counter and/or alarm that a certain particle(s) has been detected for the users benefit.

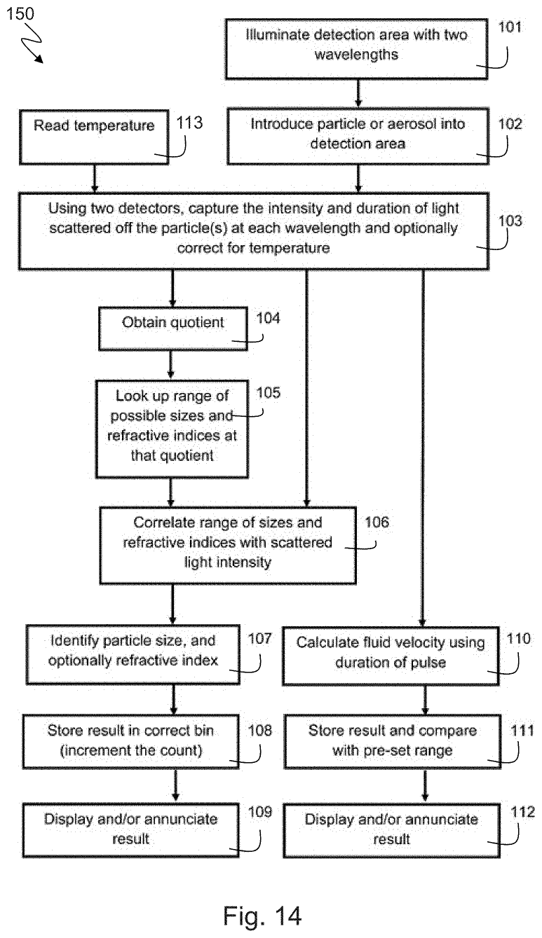

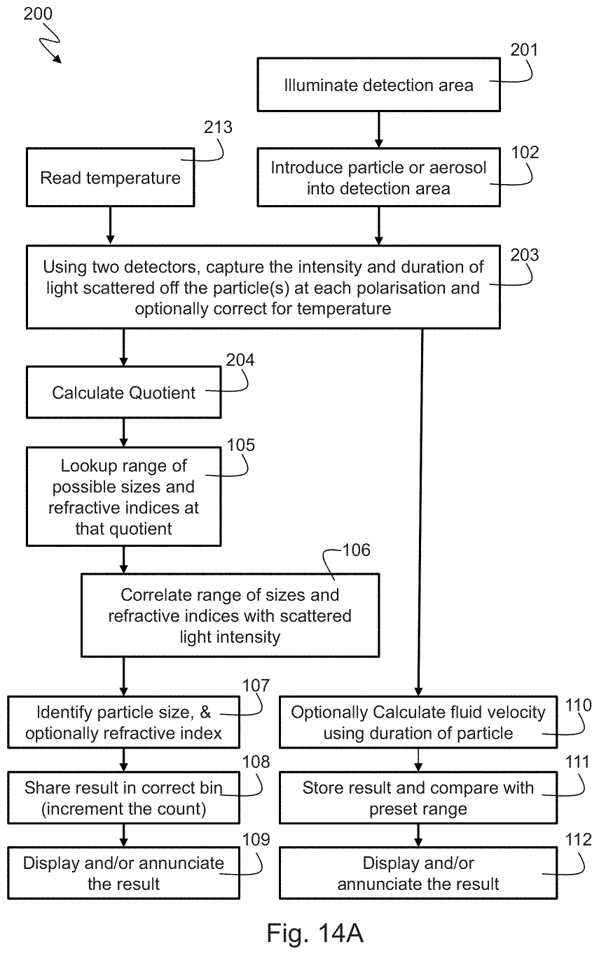

In an alternative embodiment method 150, as illustrated in FIG. 14, many of the steps of FIG. 14 are similar to those steps described above with reference to method 100 of FIG. 11 and with the same reference numerals, but steps 109 to 112 are added. Step 109 is an optional feature in which the result of the determination may be displayed. For example, the result displayed may be either a display of the size and refractive index of one or more peaks in the particle count bins, i.e. “138 nm @ 1.33”, or a display for example as shown in FIG. 37 where various particles and the associated count are displayed, or alternatively it may provide a user-friendly message, i.e. “POSITIVE for SARS-CoV-2”. In optional step 113, a measurement of the temperature of the sample is taken such that the detected intensity of the scattered light in step 103 may be optionally corrected for temperature. With reference to FIG. 12 the width of each pulse represents the time duration for which the particle is within view of the visible and infrared light wavelengths respectively. The infrared pulse will typically be of longer duration than the visible pulse because the sampling volume diameter is larger, said diameter being in proportion to the wavelength. The time duration relates inversely to the particle velocity which may be optionally computed in step 110 to assist with confirmation of the particle identification computed by computation of the particle size and, optionally the refractive index in step 107. For example, if the time duration for the visible pulse is 100 μS and the sampling diameter is 20 μm then the velocity 110 is given by: Velocity=Distance/Time, i.e. Vₚ=D/T=20/100=0.2 m/S. Alternatively, the infrared pulse duration could be used as follows. In this same example, given that the infrared wavelength is twice as long as the visible wavelength, then the infrared sampling volume is twice as large in diameter as the visible sampling volume. So the infrared pulse duration would be twice as long i.e. 200 μS while the sampling volume diameter would be twice as large i.e. 40 μm. The velocity 110 is given by Vₚ=D/T=40/200=0.2 m/S in confirmation of the result obtained before. Given a laminar flow regime, the particle is entrained within the fluid flow, so the fluid velocity 110 can be considered the same as the particle velocity. This phenomenon and this calculation provide a convenient anemometer for determining the fluid flow rate. In turn, this flow rate can be monitored to ensure that the flow rate remains within prescribed limits 111 as required for the correct operation of the disclosure. Step 112 is an optional feature in which the result may be displayed.

In a second embodiment of the disclosure, a laser source (such as a single laser source) producing both visible and infrared light, is directed through an optical chamber or housing. The chamber may be substantially light-tight against unwanted external light sources such as ambient lighting including intermittent scattered sunlight. The chamber also contains two receivers positioned to detect light scattered in a predetermined direction or range of directions, off aerosol particles that may pass through the chamber. The range of directions may typically embrace from 50° to 70° to the laser light axis, however, in one embodiment, analysis is based on a choice to integrate the light scattered in the direction of 60°±10° (from the laser axis), or any other degree of scattering as may be suitable to the situation and particle being detected and/or where the receiver cell is placed, or 55° to 65°.

The magnitude and direction of light photons that are scattered off aerosol particles has been determined here by application of the known light-scattering equations of Gustav Mie and, more specifically, the light intensity scattering matrix using the parameters of George Stokes relating to light polarisation (the Muller and Stokes phase matrices which can be determined experimentally since only intensities at different polarisations are required).

FIG. 15 charts the relative intensity of light received by two receivers that serve to integrate light scattered within the direction of 55° to 65° from the laser axis. The intensity (brightness) of scattered light shown, is in proportion to the intensity (brightness) of the originating laser light source.

In a practical embodiment of the disclosure, by using two receivers, light scattered off aerosol particles produces a first channel signal and a second channel signal responsive to visible or infrared light respectively. Inherent in each signal may be a steady offset component produced by background reflections in the said optical chamber. This offset may be zero, but it is nevertheless accounted for in calculations herein.

In some embodiments, each receiver is a PIN photodiode. Inexpensive PIN photodiodes are available with inbuilt filter coatings such that one photodiode is responsive to both visible and infrared light, while the other is responsive to infrared light only. For instance, one photodiode is positioned to receive visible plus infrared light of either normal (i.e. perpendicular) or parallel polarisation, while the other photodiode is positioned to detect infrared-only light of either normal or parallel polarisation. However, it has been discovered that the use of normal polarisations for both visible plus infrared light, together with infrared-only light, serves to minimise the possibility of ambiguity in particle size measurements.

To provide a visible-only signal, it is possible to include a photodiode to receive infrared light only, so that its signal can be subtracted from that of the visible plus infrared photodiode. However, it has been surprisingly discovered that this additional step is not necessary for the purposes of this disclosure. Accordingly, for this discussion the visible plus infrared receiver is regarded as the visible receiver.

In FIG. 15, said scattered light is scattered off particles ranging in diameter from 0.01 to 10 microns (log-log scale), at a wavelength of 532 nm (GN=green with normal polarisation), and also at a wavelength of 1064 nm (IRN=infrared with normal polarisation). Other polarisations (e.g. parallel polarisations GP and IRP) are omitted for clarity.

For each wavelength, refractive indices: n=1.33, n=1.50, n=1.75 and n=2.00 are revealed, representing differing particle chemistries or morphologies at a given size. Water vapour has the lowest refractive index at n=1.33 while at the other extreme, carbon black can have a real refractive index approaching n=2.0. Smoke and dust typically have a refractive index between 1.5 and 1.6.

For reference, FIG. 15 is illustrated with known mean particle sizes of some example smoke types—e.g. incense, cotton lamp wick and burned toast, as well as dust typified by the mean size of Portland cement particles (a known standard dust surrogate). The magnitude of each example shown here is arbitrarily set for illustrative purposes.

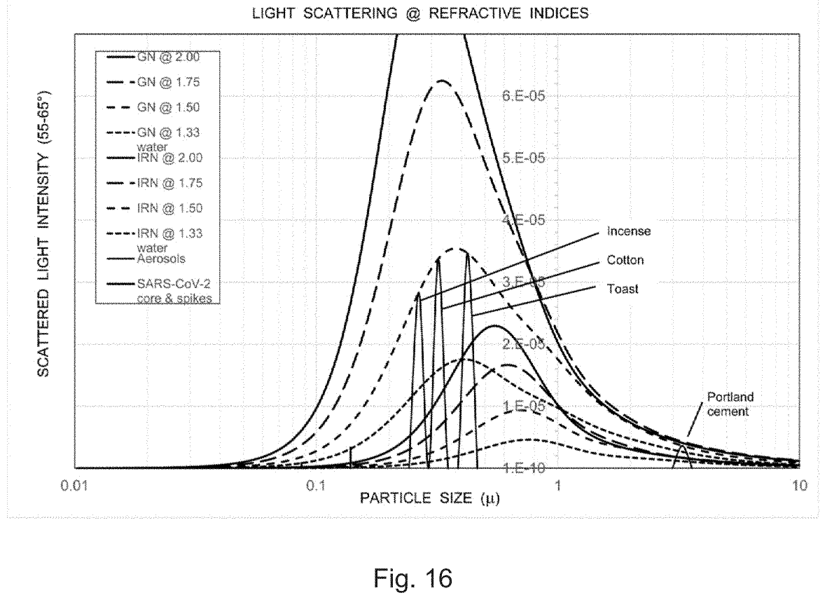

FIG. 16 contains the same data as FIG. 15, expressed in log-linear form for greater clarity of the relative magnitudes.

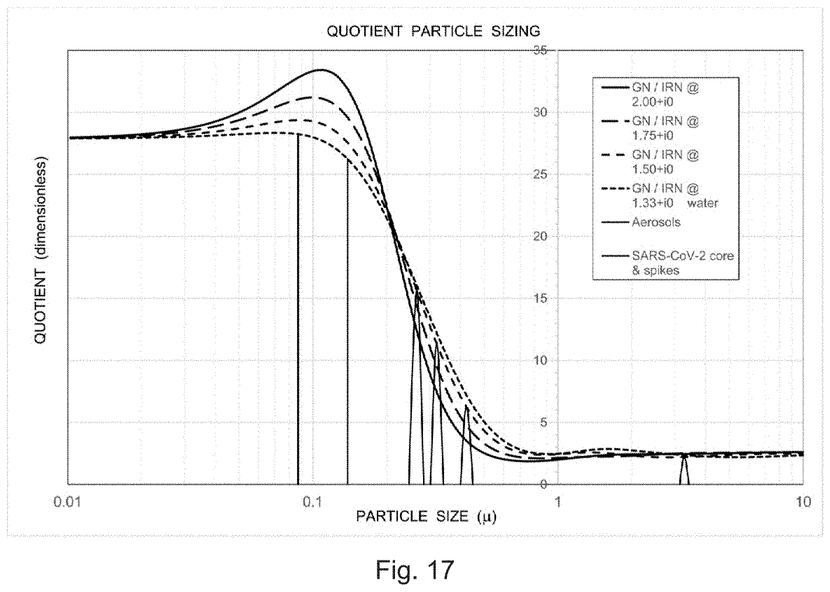

FIG. 17 presents the relative magnitude of the green signal (GN) compared with the infrared signal (IRN), in a mathematically desirable dimensionless form, as a quotient of the light scattering intensity. The same four refractive indices as used in FIGS. 15 and 16 are used here, as an example (only) of the present disclosure. As shown in FIG. 17, when an unknown aerosol is being exposed to the laser light, the size of the particles can be obtained from the quotient values using an equation of the form:

Quotient (Q)=GN/IRN [Equation 7]

where:

GN is the green signal; and

IRN is the infrared signal.

For example, using FIG. 17, if the Quotient is 10, then the particle size can lie in the following range, depending on the refractive index:

TABLE 1
Possible Particle Sizes at Possible Refractive
Indices for a Quotient of 10

0.279μ @ 2.00, or
0.321μ @ 1.75, or
0.326μ @ 1.50, or
0.347μ @ 1.33.

This relatively narrow spread of values, which equates to 0.313μ±0.034μ (or ±11%), is already better precision than could be obtained with the prior art. However, in an embodiment of the present disclosure it is possible to achieve a higher accuracy.

The inventor realised that in a particle counter, predominantly only one particle is exposed to light at a time, so the scattered light intensity depends on the particle size and refractive index of that particle, independent of the aerosol density (here, aerosol density is defined as the number of particles per unit volume).

Accordingly, the particle sizing uncertainty in FIG. 17 can be resolved with reference to FIG. 13. Using GN values, if the amplitude is 7.50×10⁻⁵, then n=2.00 and therefore the particle size is 0.279μ. Or, if the amplitude is 5.47×10⁻⁵, then n=1.75 and the particle size is 0.321μ. And so on. Interpolation is used to reveal intermediate particle sizes and refractive indices.

Curves of best fit to the data of FIG. 17 reveal that an equation of the following form could be used to calculate (approximately) the particle size Φ (microns), where Ω is the factor, Γ is the exponent and n is the refractive index:

Φ=Ω*(GN/IRN)^{-Γ}=ΩQ^{-Γ} [Equation 8]

where Ω=−0.621 ln+1.9317

and Γ=0.1609n−0.6977

Note that the factors Ω and Γ (or coefficients) shown above are for illustration only, as the exact value of these factors depend upon the calibration of the disclosure.

As an alternative to using equations of a type illustrated in Equations 8 to 10, a lookup table could be used, and applying interpolation to provide intermediate values. This table may be a 4D database with axes comprising wavelengths, quotients, refractive indices and particle sizes.

In one embodiment of the disclosure, various aerosols are introduced to the disclosure and the readings are correlated with known aerosols. For example, readings of wavelength and refractive index for various aerosols. FIG. 18 illustrates example readings of wavelength and refractive index for some (example only aerosols) which may be used for the purposes of correlation in accordance with the present disclosure. It is important to note that the present disclosure is not limited to only the information of FIG. 18, as other aerosols or information may be used for the purpose of correlation, depending on the use to which the present disclosure is put. These readings, together with any other suitable readings, may be used to create a look-up table of aerosol characterisations that is stored within the disclosure. Subsequently, readings obtained in situ may be referred to this table, in order to identify the aerosol.

Accordingly, it is made possible to produce a device according to an embodiment of the present disclosure for the detection of aerosol particles, wherein the particle size together with its refractive index can be determined accurately to three significant figures.

This information could be used to identify the aerosol particle species and thereby determine the associated risk. In the case of smoke, it could indicate the fuel being burned, and hence its flammability and toxicity. Because small particle sizes generally imply more-complete combustion or higher combustion temperatures, particle size may further indicate the level of risk associated with a given fire incident.

In the case of fire, the smoke being generated is often diluted by ambient fresh air, especially if the smoke detector is at some distance from the smoke source, so smoke density alone (as may be provided by the prior art) does not necessarily indicate the level of fire danger accurately.

In the case of sampling exhaled air, the detector of the present disclosure may be embodied as or at least incorporated into a breathalyser or any other air sampling device. The particle size and refractive index measurements may be used to identify airborne microbes such as SARS-CoV-2, which is the virus responsible for the COVID-19 pandemic. This virus has a published core diameter of 88 nm, measuring 138 nm diameter across the spikes, which lies within the high-accuracy detection range of the current disclosure. It is important to note, that the present disclosure is not limited to detecting only a virus particle of this size, the disclosure may be preconfigured to detect any selected size particle. This gives the prospect of detecting a virus, like SARS-CoV-2 in exhaled air and within an infectious room, detectable (relatively) in real time. The virus may also be contained within water droplets but it may be detectable within each droplet.

The method(s) as disclosed herein enable determination of the presence of SARS-CoV-2 particles in a fluid. With the advent of the COVID-19 crisis, a breathalyser configuration is considered useful, to be used for example, in the same way as an alcohol breathalyser, giving real-time results within a relatively short time frame, perhaps even seconds, which would represent an enormous benefit over current medical swab test methods requiring days to produce a result. Another embodiment of the current disclosure may have the detector configured for SARS-CoV-2 detection and in the form of a hand-held apparatus. The physical embodiment of this apparatus would be different from other embodiments because of the particular need for a mouthpiece, an exit filter, no aspirator and a portable configuration, and where a breath sample provided by a person being tested is exhaled and blown into the detection device. That may produce an aerosol of the person's breath, which can be analysed for specific particles, such as SARS-CoV-2, as may be done with any particle detection apparatus or method as disclosed herein.

### Third Embodiment—An Alternative Quotient Method

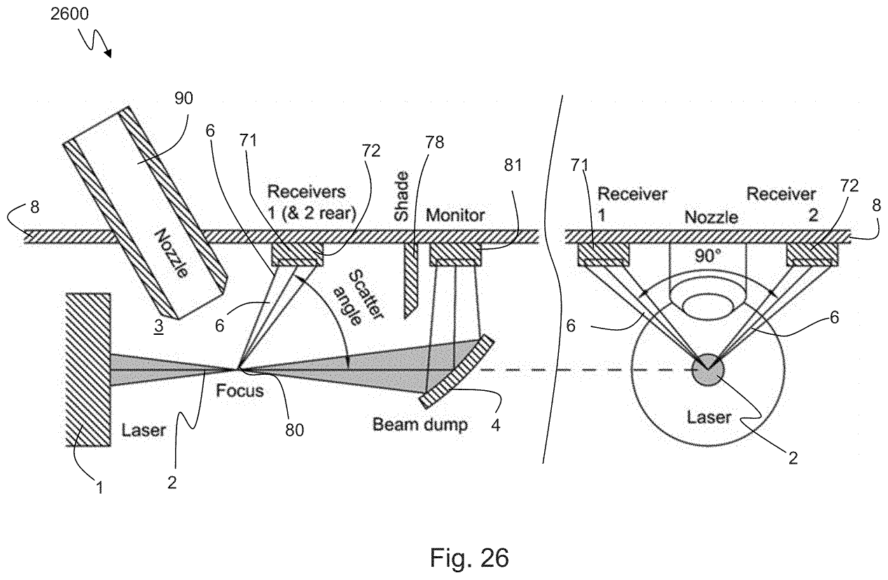

As an alternative to the embodiments disclosed herein before, the present disclosure may be implemented by the use of a single-wavelength and two-polarisations. By this, we mean, that the embodiment of this aspect of disclosure uses one laser of a particular wavelength which scatters light off a particle, with two receivers positioned to detect light scattered at Normal (i.e. perpendicular) and Parallel polarisation respectively. Receiver configurations as illustrated in FIGS. 4, 5 and/or 6 may be used, but the receiver configuration of FIG. 26 shown in side view and end view looking back towards laser 1 may be used.

Using a single wavelength source has significant advantages over a two-wavelength source. Using a single optical source that generates two wavelengths (e.g. a diode-pumped solid state laser source with nonlinear frequency conversion to convert a portion of light at a fundamental frequency—e.g. infrared light at 1064 nm—to light of a frequency-converted frequency—e.g. visible light at 532 nm or green light—is that this wavelength conversion process introduces a lot of noise (in the form of e.g. fluctuations in the optical output power or the centre frequency of the output light). The Signal-to-Noise-Ratio (SNR) directly determines the ability to decipher between similar particle species. The SNR can be about 1000:1 or better. In other words, a poorer noise level will blur the identification of particle species. But even a poor noise level should allow significantly better aerosol species identification than prior art (that simply identifies “smoke” or “dust”). However, for specific identification of a particular particle species such as SARS-Cov-2, a SNR of at least about 1000:1 may be used. The noise level can be improved by compensation using an optical power monitor (e.g. incorporated in the laser body, or added to the beam dump, either directly in line with the beam or capturing light reflected off the beam dump as shown in FIG. 26 and FIG. 37, each shown in side view and end view looking back towards laser 1). However, with a two-wavelength arrangement, the two wavelengths have different noise contributions, that is, in general, the noise sources are not correlated, so it becomes more difficult to compensate since two optical power monitors, each tuned to a different wavelength, are required.

With reference to FIG. 26, detector 2600 is shown in side view and end view looking back towards laser 1, an illustration of a dual polarisation configuration, the figure reveals two important features. Firstly, two receivers 71 and 72 are placed at 90° to each other with respect to the beam 2, with respect to the incoming light scattered from the particles under test. Receivers 71 and 72 are shown as surface mounted to pcb substrate 8, however further arrangements may optionally include an angled mounting block (not shown) to orient receivers 71 and 72 to be directly angled towards the focus location of beam 2. A polarising beam splitting element (e.g. a polarising beamsplitting cube), not shown, may optionally be placed in the path of the incoming light 2 to split the incoming light 2 into two orthogonally polarised components, each of which is directed to a respective optical receiver. One receiver detects Normal polarised light, while the other detects Parallel polarised light. During setup, a (cylindrical) laser housing is rotated until the polarisation purities are perfected, then the laser is fixed in that position.

An additional receiver 81 is placed to monitor and correct for fluctuations in the laser power in beam 2. This monitor 81 could be a feature of any and all of the embodiments previously disclosed herein. Much of the laser power in beam 2 is dissipated in the beam dump 4, but a small proportion is sent to the monitor 81. This proportion may alter over the long term as a result of soiling, but it is the comparatively short-term fluctuations that are necessary to compensate for. A shade wall 78 is included to prevent light scattered from the sampling volume (at the laser focus location of beam 2) from reaching monitor 81 and confusing the monitoring signal.

Then, a quotient of the two signals received by receivers 71 and 72 may be derived, and then related to refractive index and particle size by virtue of a look-up table. This quotient can be applied to ultraviolet, green, blue, visible or infrared light (the wavelength simply determines the effective span of particle sizes discernible, e.g.: about 0.03 m to 1.0 m for green light vs say: about 0.06 m to 2.0 m for infrared light).

Somewhat readily available laser light sources are, for example but not by way of limitation, a choice of Green with Parallel polarisation (GP), Green with Normal polarisation (GN), Infrared with Parallel polarisation (IRP), and Infrared with Normal polarisation (IRN). The Green wavelength may, for example, be of about 532 nm, and/or the Infrared wavelength may be of about 1064 nm. In use, light generated by the laser sources is focused to impinge upon particles within an aerosol.

Light scattered off the aerosol particles within an angle of 60°±5°, for example, is integrated upon a pair of PIN photodiode receivers 71 and 72. One receiver is responsive only to Infrared light. Another receiver is responsive to both Infrared light plus Green light with a relative sensitivity of, for example, Ψ=0.84 compared with the infrared light.

With reference to FIG. 4, 5, or 6 for example, in the side elevation view (with the laser on the left and beam dump on the right), the scatter angle used is typically on the order of 60° off the laser beam axis. This angle is a design choice. In the frontal elevation view (looking directly towards the laser), for example detector arrangements 1900, 2000, and 2100 FIG. 19, 20 or 21, the two polarisations are produced at approximately 90° to each-other. This angle is determined by physics, but the discrete polarisations may be conveniently distinguished by mounting the receivers at ±45° with respect to vertical, to suit the horizontal PCB as shown. The cylindrical laser housing is rotated until the Normal polarisation is aligned with one receiver, while the Parallel polarisation would align with the other receiver.

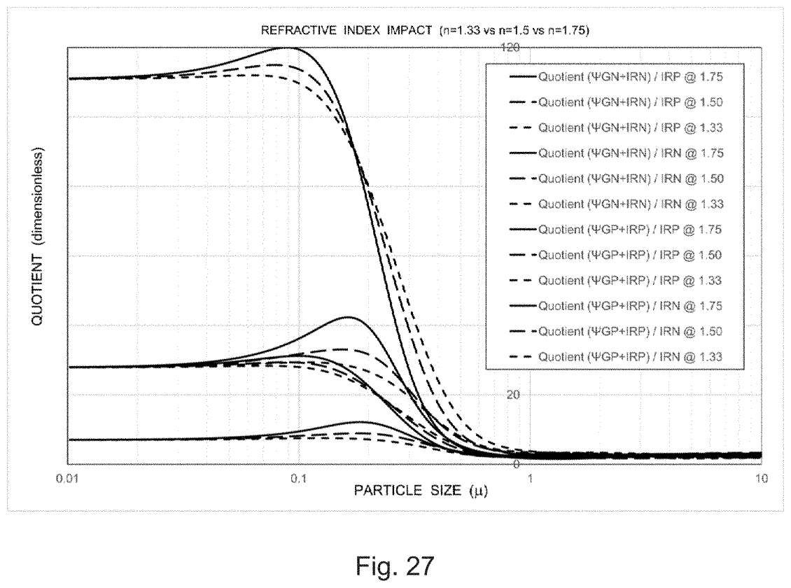

Signals obtained from the two receivers are proportional to the magnitude of light integrated on the photodiodes. This pair of signals can be examined to determine the concentration, size, and refractive index of the particles in view. This process begins by taking a quotient of the pair of signals. As illustrated in FIG. 27 are the calculated results of taking a quotient of a pair of signals, namely (ΨGN+IRN)/IRP at refractive indices of 1.33, 1.50 and 1.75 respectively, or the quotient of a pair of signals which are (ΨGN+IRN)/IRN at refractive indices of 1.33, 1.50 and 1.75 respectively, or the quotient of a pair of signals which are (ΨGP+IRP)/IRP at refractive indices of 1.33, 1.50 and 1.75 respectively, or the quotient of a pair of signals which are (ΨGP+IRP)/IRN at refractive indices of 1.33, 1.50 and 1.75 respectively, all charted against the particle size (logarithmic scale).

A very large quotient implies a small divisor, which may be considered undesirable in terms of relative signal-to-noise ratio, depending on the use to which this disclosure is applied. Also, it may be desirable to have the smallest “overshoot” in the vicinity of 0.1μ particle size, to minimise ambiguity. By inspection, the most desirable sets of data having regard to FIG. 27 results from the quotients of: (ΨGN+IRN)/IRN.

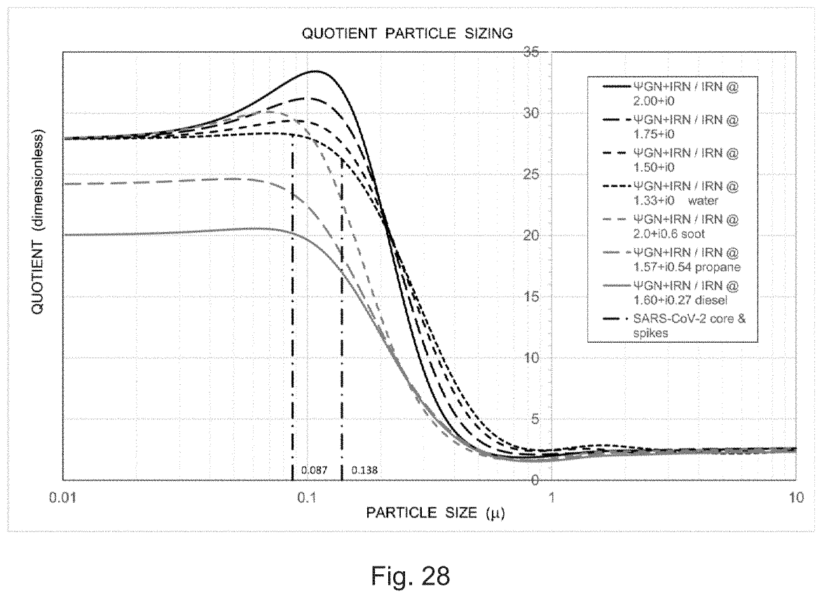

Taking a closer look at this arrangement, we obtain FIG. 28 which illustrates results from the quotients of (ΨGN+IRN)/IRN, where for example, the GN receiver is sensitive to IRN at the same time, and typically Ψ=0.84 due to the relative sensitivity of the receiver to green compared to infrared, in this embodiment. Or more broadly, quotient is (ΨVN+IRN)/IRN, where with reference to VN, V means Visible, to encompass Blue, Green or other choice of visible colour. We previously mentioned that violet or even ultraviolet could be useful, except that at present relatively inexpensive and small receivers with adequate sensitivity at such short wavelengths are not generally available.

Several additional refractive indices are considered, including soot and smoke which have complex refractive indices (a real part plus an imaginary part: m=n+ik). The imaginary part is a measure of the light absorbance of the particle. Also indicated is the size of the SARS-CoV-2 virus particle, measured across the body (87 nm) and across the spikes (138 nm)—only the latter size is expected to be resolvable at the wavelengths in use.

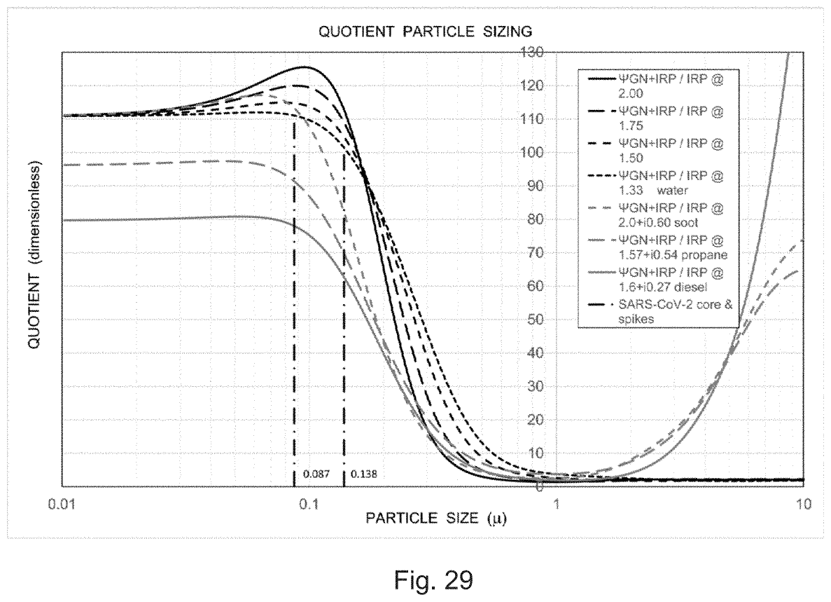

For comparison, in FIG. 29, the quotients of: (ΨGP+IRP)/IRP have been charted and we see the high quotient values obtained around 0.1μ diameter, as well as high values above 2.0μ in the case of complex refractive indices. These high values may be considered, in this particular example only, to cause ambiguity when comparing particles either side of 1.0φ. These results thus confirm the aforesaid preference for using the quotients of: (ΨGN+IRN)/IRN.

However, the use of two wavelengths requires the use of, for example, a compound achromatic lens typically comprising a flint glass lens bonded to a crown glass lens, whereby through detailed calculation and careful design and manufacture, the differing refractive indices of these two glasses is used to produce a common focal point for the two wavelengths.

It has been found that for a laser producing light of two unique wavelengths, each wavelength has some degree of instability in brightness. Surprisingly the two wavelengths taken together, such as in calculating a quotient, can tend to amplify this instability rather than cancel this instability. This is because the instabilities in each wavelength are not necessarily correlated.

### Fourth Embodiment—A Dual Polarisation Method of Particle Classification

A single wavelength laser can be employed by using its two available polarisations—mutually independent Normal (perpendicular) and Parallel orientations—referred to herein as GN and GP respectively when referring to light with a single wavelength in the green region of the visible spectrum and IN and IP when referring to orthogonal polarisations of an infrared light beam. Any possible instability in brightness for either polarisation, would, generally, be correlated. The two polarisations taken together, such as calculating a quotient, would tend to cancel this instability.

By employing light of a single wavelength e.g. green (G) or infrared (I) beam to illuminate the particles in the detection zone, the need for an achromatic lens is avoided, and despite using a simple lens, the focal point is the same for either polarisation since the focal distance is determined by the wavelength of the light, not the polarisation.

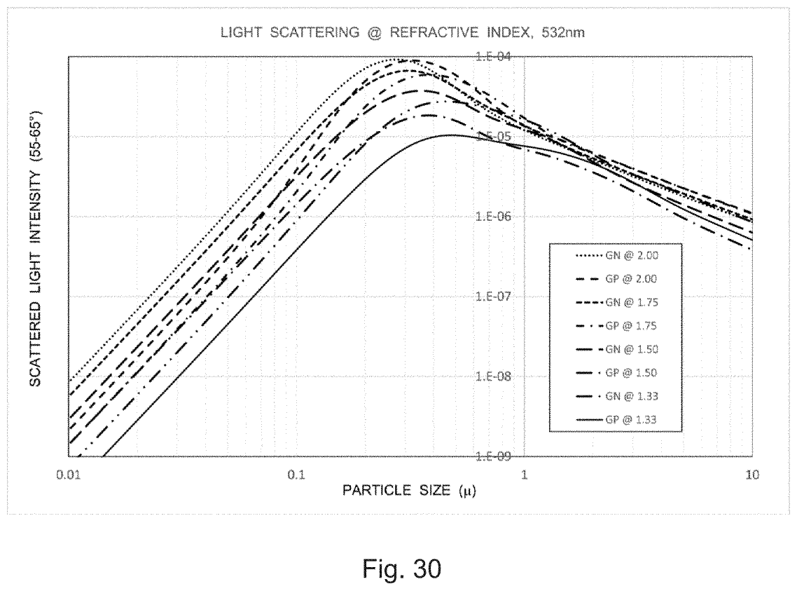

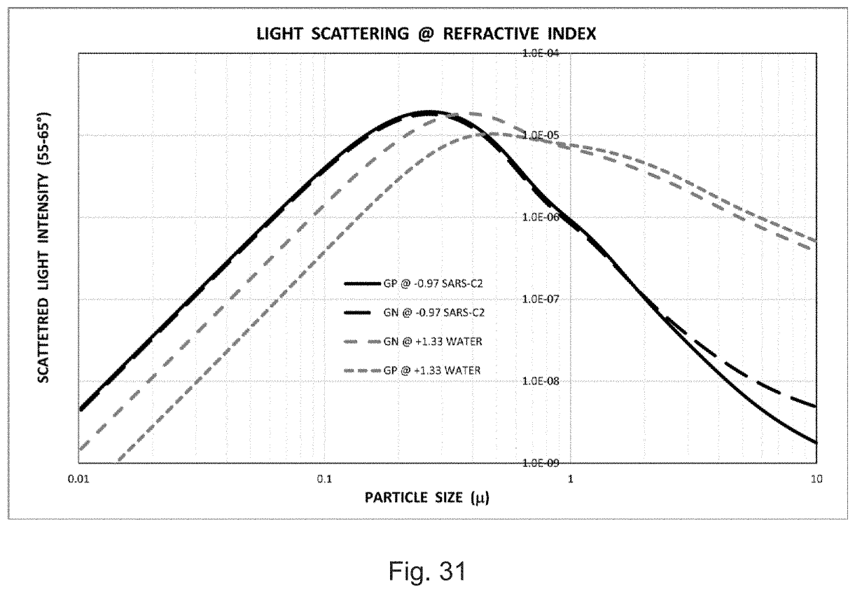

FIG. 30 illustrates the scattered light intensity at various refractive indices using 532 nm (Green) and two polarisations—Green Normal (GN) and Green Parallel (GP)—over the span of particle sizes of interest (log scales). Recent studies, for example Computation of Refractive Indices of Corona Viruses through Reverse Calculation, by Srinivasan Kuppuswamy et. al, Current Optics and Photonics Vol. 4, No. 6, December 2020, pp. 566-570, indicate that the refractive indices of corona viruses through reflectance analysis of a virus solution are negative for irradiation by ultraviolet light such as between about 400 nm and about 420 nm and also that the infectious bronchitis viruses (family of novel corona viruses, COVID-19) have higher negative refractive indices as compared to other corona viruses. The refractive index of the SARS-CoV-2 (SARS-C2) corona virus responsible for the COVID-19 disease is reported to have a refractive index of about −0.97 at an irradiation wavelength of about 415 nm FIG. 31 illustrates the scattered light intensity of a SARS-C2 solution with a negative refractive index of −0.97 compared with water having a refractive index of 1.33 as measured at two incident wavelengths (Green GN) and infrared (IR) and two polarisations (N) and (P) over the span of particle sizes of interest (log scales). It is instructive to note that there is essentially no change in scattered light intensity, with change in polarisation. This is unlike any other aerosol yet studied—a phenomenon which can be exploited for conclusive identification of the SARS-C2 virus.

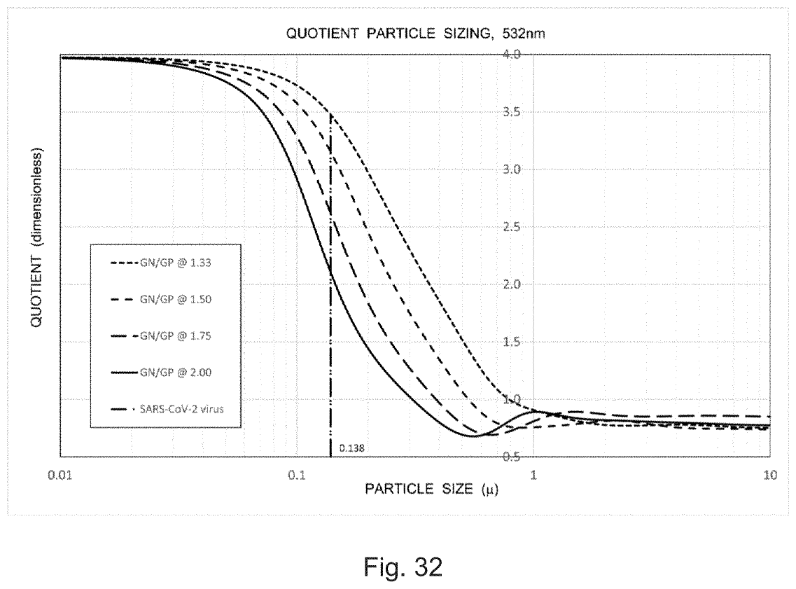

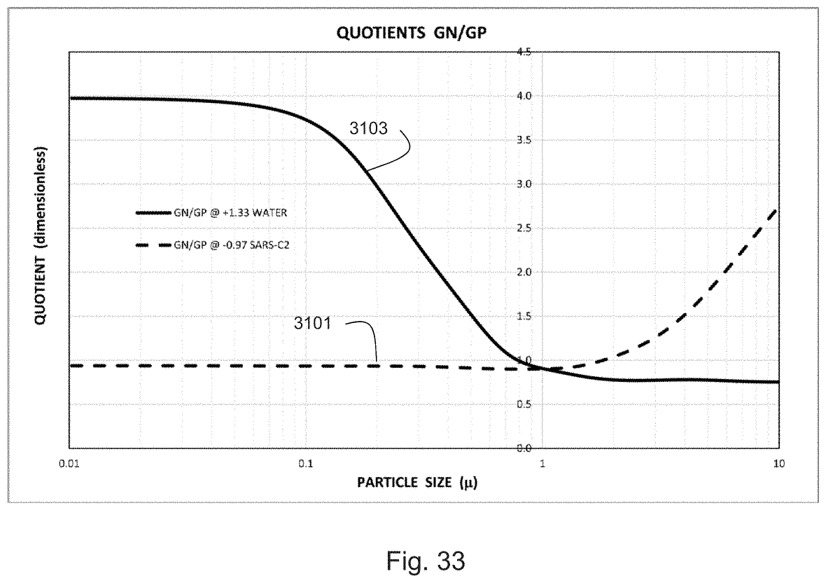

FIG. 32 illustrates taking the quotients of Green Normal (GN) and Green Parallel (GP), at the various refractive indices. In this embodiment, the quotient is determined by an equation of the form:

Quotient (Q)=GN/GP Equation 14

where:

GN is the signal with Normal polarisation; and

GP is the signal with Parallel polarisation.

FIG. 32 illustrates a quotient GN/GP and particle sizing at 532 nm. Here we see that the value of RI has a very large influence on the quotient values, compared with the charts in FIGS. 27, 28 and 29. Accordingly the use of this GN/GP quotient can provide a desirably high level of discrimination of refractive index.

FIG. 32A shows a graph of the Quotient of a SARS-C2 solution 3101 with refractive index of −0.97 compared with water 3103 with refractive index of 1.33 with illumination by 532 nm light (G) and detection at two polarisations (N) and (P). The significant difference in the quotient between the scattered light detected at orthogonal polarisations (N) & (P) between virus and water is noted which provides excellent differentiation for conclusive identification of the SARS-C2 virus. Unfortunately, this quotient calculation does not offer a size differentiation to resolve the size ambiguity of FIG. 31, however for simple detection of the SARS-C2 virus this is not necessary.

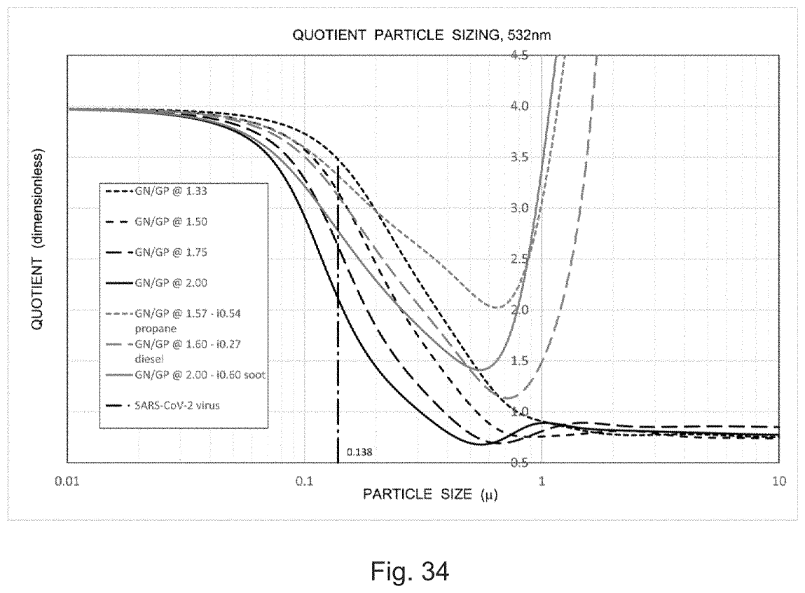

With reference to the method using normal and parallel polarisations, such as for example in Equation 14, it is also necessary to consider if there is any ambiguity of particles with a complex refractive index, and make allowance for this in determining the outcome of this embodiment of disclosure, as illustrated in FIG. 34.

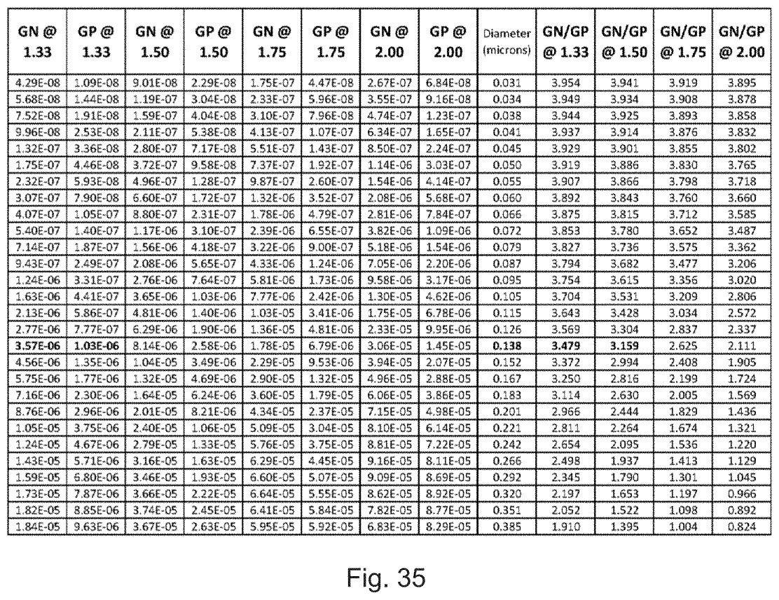

FIG. 35 illustrates an example data table (portion thereof) but related to the GN/GP quotient. FIG. 35 tabulates some of the data of FIGS. 30 and 31, being results obtained from Mie light scattering calculations for GN and GV, over a range of RI, and over the span of particle sizes of interest. This forms part of the look-up table. The numbers in bold draw our attention to the SARS-CoV-2 virus which has a published diameter of 138 nm [Scientific American, July 2020, p 3]. Its refractive index is somewhere between 1.33 and 1.50, obtained by interpolation.

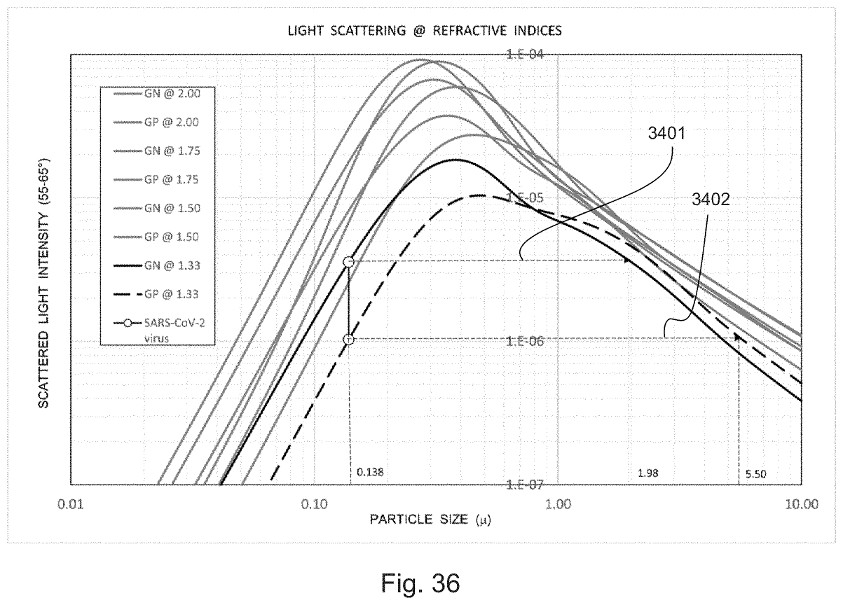

It is possible to deduce the particle size and RI without using the convenient quotient calculation, as follows: With reference to FIG. 36, in the situation where a particle that enters the detection zone, and after applying a universal constant of calibration (determined by the apparatus), the magnitude of the scattered light received in this example equates to 3.5×10⁻⁶ at Normal polarisation, and 1.03×10⁻⁶ at Parallel polarisation.

From FIG. 36 and the table illustrated in FIG. 35, we see that the 3.58×10⁻⁶ magnitude matches the Normal 1.33 RI curve at a particle size of 0.138μ, and matches the Parallel 1.33 RI curve at a particle size of 0.138μ. These sizes correspond, so therefore the particle can be considered to be 0.138μ diameter with an RI of 1.33.

With reference to FIG. 36 (see horizontal arrows 3401 and 3402), we see by inspection that alternative interpretations of this input magnitude data could suggest a particle size of 1.98μ in the case of Normal polarisation and 5.50μ in the case of Parallel polarisation. These two sizes do not correspond, so these sizes are both false. Accordingly, this process removes any ambiguity.

So we can store the result that the combination of GN=3.5×10⁻⁶ with GP=1.03×10⁻⁶ represents a particle size of 0.138μ (138 nm) with a RI of 1.33. This is a unique combination throughout the whole data table, and has (in this instance) identified the SARS-CoV-2 virus.

In accordance with various aspects of the disclosure, it is possible to use two light sources generating unique wavelengths of unpolarised light (such as two LED's, in a nephelometer configuration)—using the quotients ΨG/IR or more broadly ΨV/IR. It is equally valid to use a light source or sources generating two polarised wavelengths (the polarisations of each wavelength being either Normal or Parallel), one wavelength with two polarisations, or two wavelengths unpolarised (any one of which, or any combination of which may be used in association with an appropriate look-up table).

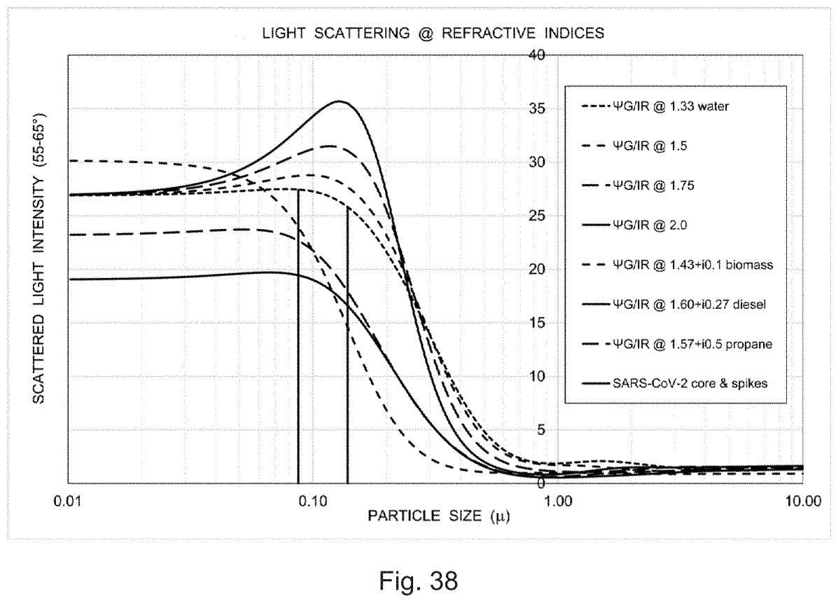

FIG. 38 is a chart obtained by using an unpolarised visible and an unpolarised infrared wavelength, such as one would obtain from a pair of LEDs. In this case, the quotient is obtained from ΨG/IR, or more broadly ΨV/IR. It can be understood that the requirement is to have any combination of two wavelengths or two polarisations or both, in order to obtain the distinct channels of data from which the amplitude and the quotient can be obtained, and used in conjunction with a dedicated look-up-table, so as to determine the particle size and refractive index of particle(s) in view.

### Fifth Embodiment—Single Wavelength Excitation-Dual Polarisation Detection

According to a further embodiment of the present disclosure includes a method 200 for identification and classification of particles in a fluid sample as depicted in FIG. 14A. Many of the steps of FIG. 14A are similar to those steps described above with reference to method 100 of FIG. 11 and method 150 of FIG. 14 with the same reference numerals. Method 200, however, uses a light source having only a single wavelength of light which illuminates the detection area in step 201. In step 203, scattered light from the particles or aerosol in the detection area is detected using two receivers which are each sensitive to different polarisations of the scattered light. In some embodiments, a first of the two receivers is sensitive to scattered light at a first polarisation and the second receiver is sensitive to scattered light having a second polarisation, where, in some embodiments the first polarisation is Normal (N) polarisation and is orthogonally oriented with respect to the second, polarisation, namely Parallel (P) polarisation. The scattered light 6 is depicted as being detected at a scatter angle of about 60° from the axis of light beam 2 however this scatter angle is a matter of choice and can be varied to optimise the scattered light 6 impinging on receivers 71 and 72.

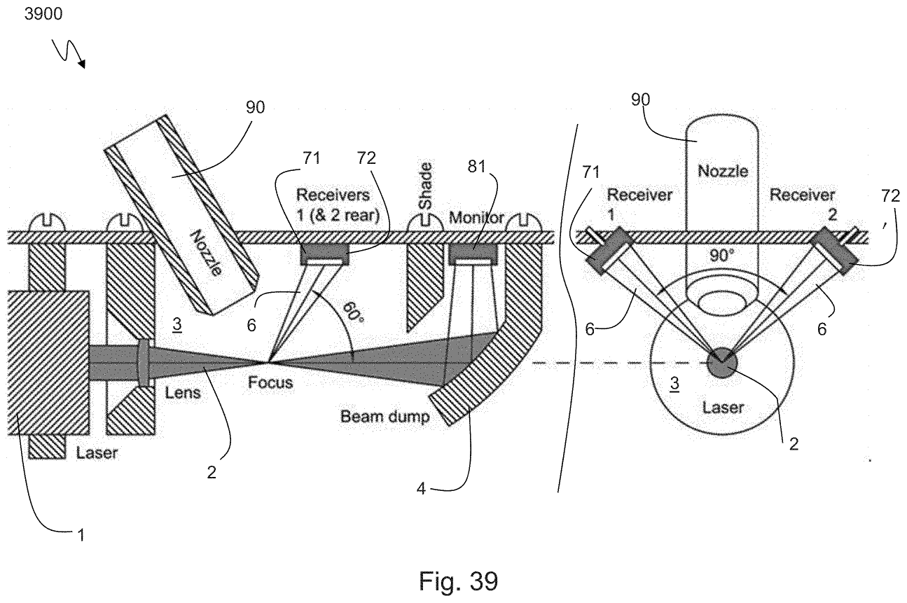

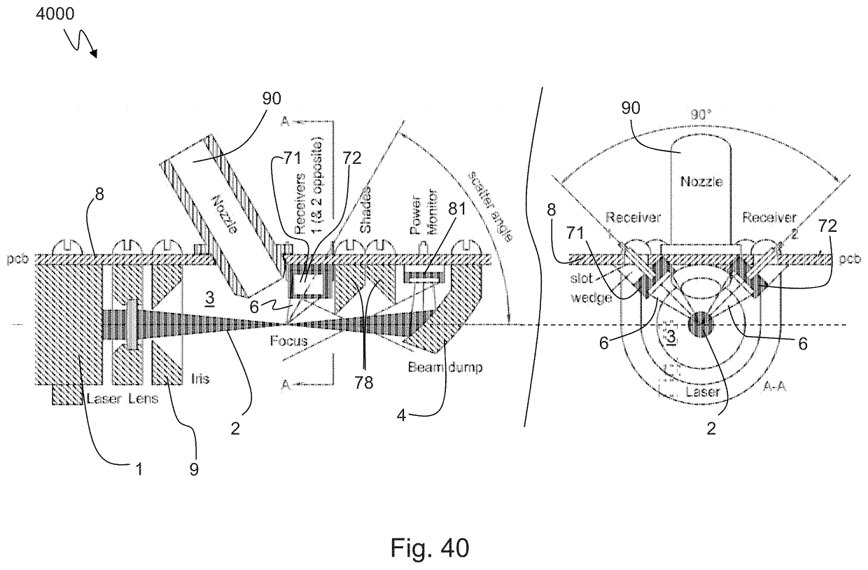

Similar to the description of the third and fourth embodiments discussed above, and with reference to the schematic depiction of detector arrangements 3900 and 4000 shown in side view and end view looking back towards laser 1 respectively shown in FIG. 39 and FIG. 40 (and similar to that of detector 2600 of FIG. 26) a single wavelength laser source 1 can be used to illuminate the particle stream in the detector device 3 as described herein. In some embodiments, the light 2 from laser source 1 is a polarised single wavelength source. The wavelength of light 2 may be either an infrared, visible (e.g. green), or ultraviolet wavelength. Polarised light 2 is scattered from the particles entering the chamber 3 from nozzle 90 and scattered light 6 is detected by two receivers 71 & 72. Light 2 which is not scattered by the particles in chamber 3 is captured by beam dump 4 and additional receiver 81 is placed to receive at least a predetermined portion of the light captured by beam dump 4 to monitor and correct for fluctuations in the laser power. FIG. 40 shows an optional iris 9 and shades 78 which serve to minimise any stray light causing unwanted crosstalk between receivers 71 and 72 and the optical power monitor 81.

In the present embodiment, receivers 71 and 72 are responsive to different polarisations of scattered light 6 and are located with a relative scatter angle between them of 90° such that a first receiver 71 is configured to detect scattered light 6 at a Normal polarisation and second receiver 72 is configured to detect scattered light 6 at a Parallel polarisation with respect to the polarisation of the illuminating light beam 2.

This embodiment has been found to have improved signal to noise ratio (SNR). The SNR directly determines the ability to decipher between similar particle species. The SNR can be about 1000:1 or better. In other words, a poorer noise level will blur the identification of particle species. But even a poor noise level should allow significantly better aerosol species identification than prior art (that simply identifies “smoke” or “dust”). The noise level can be improved by compensation using a monitor (albeit a monitor incorporated in the laser body, or added to the beam dump, either directly in line with the beam or capturing light reflected off the beam dump as shown, for example in FIG. 26 and FIG. 39).

### Further Embodiments

In one embodiment of the current disclosure, the smoke density value is combined with the particle size value to produce a new value representing the level of risk. In one particular embodiment of this disclosure, the level of risk Θ_{GR} is obtained from the quotient of the smoke density and the particle size with an equation of the form:

Θ_{GR}=K*D*(Φₘ⁻²) [Equation 12]

where:

Θ_{GR} is the risk factor;

K is a constant of scaling;

D is the smoke density count in particles per second; and

Φₘ is the mean particle size averaged over that second.

In yet a further embodiment of the disclosure, the data produced is logged and analysed over time, to determine the rate of change in smoke density and particle size. The risk factor output level is adjusted according to the rate of acceleration of the pyrolysis event with an equation of the form:

Ψ_{GR}=dΘ_{GR}/dt [Equation 13]

Additionally, it is possible to provide an output responsive only to smoke, for example, and another output responsive only to dust, for example. In this way, an embodiment of the present disclosure can be set with relatively high sensitivity in order to provide the early warning of an overheating, smouldering, pyrolysis or fire event without false alarms due to dust or steam aerosols. While in addition, it separately provides an output responsive to dust levels for the purpose of health hazard or maintenance warnings.

Benefits similar to all of the above could be achieved using an infrared laser of 946 nm and a BIBO (bismuth triborate) crystal to produce a blue laser of 473 nm for example as an alternative.

In one embodiment of the disclosure, it is configured as a nephelometer rather than a particle counter. A nephelometer responds to the cloud density—using the bulk scattering of light off a large number of particles—and takes an average reading of all the particles in view. Accordingly, for this embodiment, the laser is collimated to a parallel beam (such as 1 to 3 mm diameter) and provides a cylindrical scattering volume.

In another embodiment of the disclosure it is configured as a particle counter. This is achieved by simple modification of the beam focusing within the laser optics. Accordingly, by the simple inclusion or omission of a lens, the same device could perform as either a nephelometer or a particle counter.

In another embodiment of the disclosure, it is configured as both a particle counter and a nephelometer.

Configured as a particle counter, the disclosure responds to the light scattered off desirably one individual particle at a time, requiring the laser to be focussed to a tiny spot, for instance, small enough to contain only said one particle at a time (said spot being typically on the order of one to two micron diameter). The prior art for particle counting, using a single wavelength laser, offers some degree of particle size measurement, according to the brightness of the light scattered. However, this process is subject to the albedo of the particle which may vary due to shape, refractive index or chemistry. Moreover, it is possible for two or more tiny particles to be in view together. Alternatively, it is possible for a large particle to be only partially in view. In these cases, the particle size is misrepresented by the brightness level received. Moreover, it is common for particle counters of the prior art to become saturated if the aerosol density is very high. Furthermore, with reference to FIGS. 15 and 16 we see that the light scattering brightness is affected by the refractive index, more so than the particle size, so measurements based solely on brightness can be considered unreliable.

Therefore, in the present disclosure, the use of two wavelengths projected from a common source is considered to provide a more reliable means for measurement of particle size for a particle counter, especially so because of the substantial certainty that the same particle can be exposed to each wavelength at the same moment of measurement.

In a further variant of the nephelometer embodiment or the particle-counting embodiment of this disclosure, the laser may be pulsed in order to conserve energy and reduce temperature rise, and to improve the signal-to-noise ratio of the signals.

In an alternative embodiment of the disclosure, and with reference to FIG. 19, the detector comprises a visible+infrared laser 1 producing a coaxial pair of collimated beams 2 within a chamber 3. The chamber may be opaque to minimise interference from ambient light, especially transient ambient light such a sunlight scattered from a passing vehicle. At the far end of the chamber, a beam dump 4 absorbs the remnant laser light energy to avoid swamping the received light. Gaseous medium such as air that may contain aerosol particles may be introduced via a nozzle 90 and can be constrained to flow across and through the laser beams 2. A small proportion of the laser light 6 is scattered off each particle in all directions, as they pass through the beam. Some of this scattered light falls upon the receivers 71 and 72, said receivers may be mounted on a common substrate such as a printed circuit board. The need for optical enhancement, such as receiver focussing lens(es) or iris(es) commonly used in the prior art, can be avoided.

This scattered light is typically many orders of magnitude weaker than the laser light, so it is necessary to avoid swamping the scattered light with said laser light. The tight beam control provided by a laser light source makes this possible, using comparatively minimal precautions in the design of the chamber. The same tight beam control makes it possible to locate two receivers close to each other, so as to obtain reliably comparable signals from each receiver.

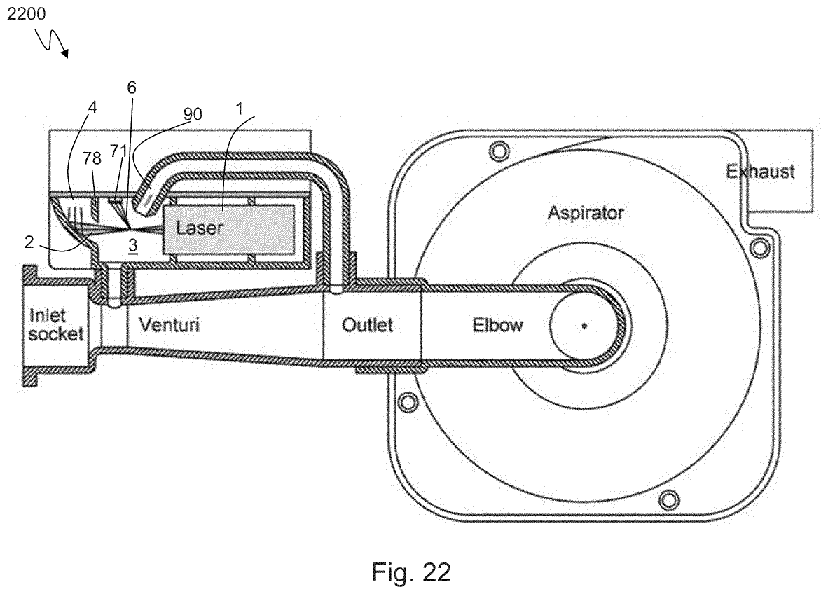

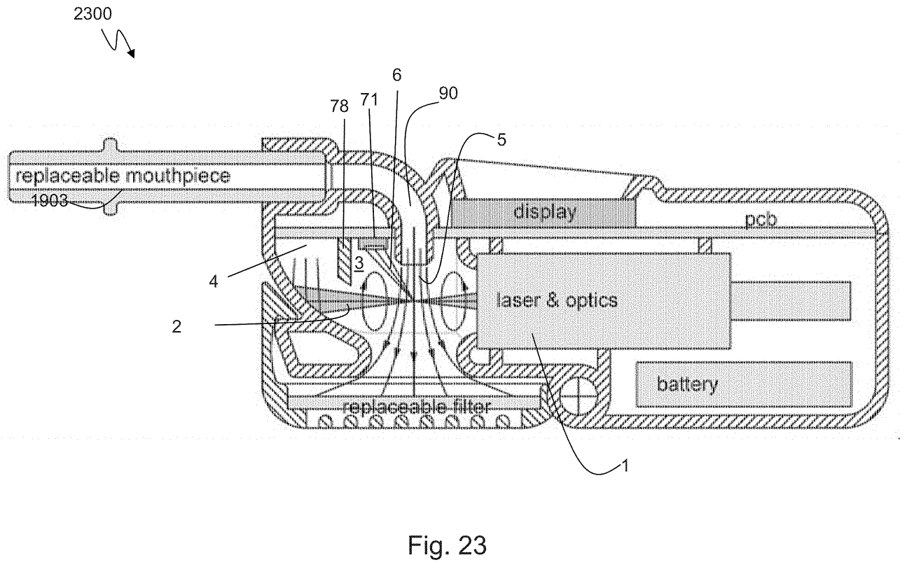

Another embodiment of the disclosure is illustrated in FIG. 22. In this example, a long, small-bore pipe is reticulated across the ceiling of a monitored zone and connected to the pipe inlet. The long pipe contains a series of small holes acting as sampling points. Air (that may contain smoke and/or dust and/or other particles) is drawn from all sampling points, under pressure from the pump or aspirator, towards the detector. This pipe air flow needs to be of relatively high velocity, such as at least 1 metre/sec, in order that the furthest air samples can reach the detector expeditiously.

However, the air flow passing through the detection chamber can be set to a low velocity, to maximise the time for which a given particle is exposed to the light beam, thereby reducing the necessary bandwidth of the receivers and signal processing. This low velocity is conveniently achieved by taking a small proportion such as 2% of the sampled air through the chamber as shown in FIG. 22 using a venturi. This small proportion is adequate for the purposes of the disclosure, because the particle density per unit volume does not change. This small proportion also minimises the quantum of contaminants entering the chamber which could eventually soil said chamber.

The particle detector as illustrated in any one or any combination of FIGS. 4 to 6, 19 to 21 may be used in conjunction with the embodiment of FIG. 22. As illustrated the low velocity of the impinging air flow serves to minimise soiling that could otherwise be caused by dust settling-out from said air flow. In other words, the Reynolds Number may be kept very low so that dust particles substantially remain entrained within the air stream. Moreover, the receivers and their substrate can be mounted with the PCB substrate uppermost to further avoid soiling under the force of gravity. These soiling-avoidance techniques assist in maintaining the calibration and sensitivity of the detector in the long term, such as 10 years. This longevity is achieved without need for dust filtration and the attendant maintenance regimen, however a coarse dust filter or settling void may be included upstream of the chamber, to avoid possible insects, grit and debris.

In some embodiments, two receivers are positioned relatively side-by-side, either longitudinally as in FIG. 4, or laterally as in FIG. 5, with respect to the coaxial laser beams.

The coaxial laser beams are polarised. When both Parallel and Normal polarisations are to be used, a pre-set rotation of the laser with respect to the receivers can be used to optimise the detection performance. Laser rotation is set such that one receiver is aligned with normal polarisation while the other is aligned with parallel polarisation. Accordingly, in one embodiment of the disclosure illustrated in FIGS. 5 and 6, the receivers are mounted on either side of the laser beam while subtending a radial angle of substantially +45° and −45° respectively to the laser centre.

Using normal polarisation for the shorter wavelength light, together with normal polarisation for the longer wavelength light, has been determined to reduce ambiguity in the determination of particle size and refractive index.

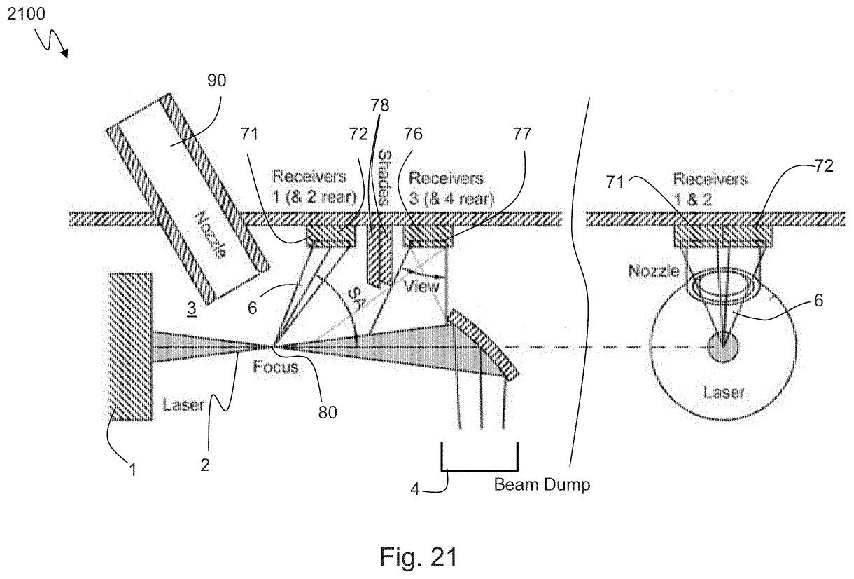

It is known from Mie light-scattering theory that the intensity of light scattered in any given direction, is determined by the particle size and refractive index in a predictable way. Especially for particles larger than the wavelength of light, typically the scattered light intensity is brighter in the forward-scattering region, less bright in the backward-scattering region, and greatly reduced at right-angles to the laser beam. This offers an opportunity to further refine the particle size measurement. Multiple receivers could be placed at differing polarisations and scattering angles to the beam axis, to enhance the ability to determine particle sizes, especially for large particles, in order to characterise dust types. Therefore, in one embodiment of the disclosure, one or more additional receivers are set at a small angle to the laser axis, such as 10°, for example one or more of receivers 73, 74 or 75 of FIG. 20. Data from this receiver is compared with data from another receiver such as receivers 1 or 2, 71 or 72 respectively as seen in FIG. 20. This data comparison is used to refine the detection and classification of dust. Additional receivers may also be used such as, for example receivers 3 and 4, 76 and 77 respectively as seen in FIG. 21. Receivers 3 and 4 may optionally be optically separated from receivers 1 and 2 (71 and 72) by shades 78 to prevent cross talk between the receivers and to ensure that receivers 3 and 4 (76 and 77) are sampling a different portion of the laser beams, e.g. away from the focal point 80. Shades 78 may also be employed to minimise or eliminate stray light reflected from the internal surfaces of the chamber from reaching the receivers, for example as shown in FIGS. 21 and 26.

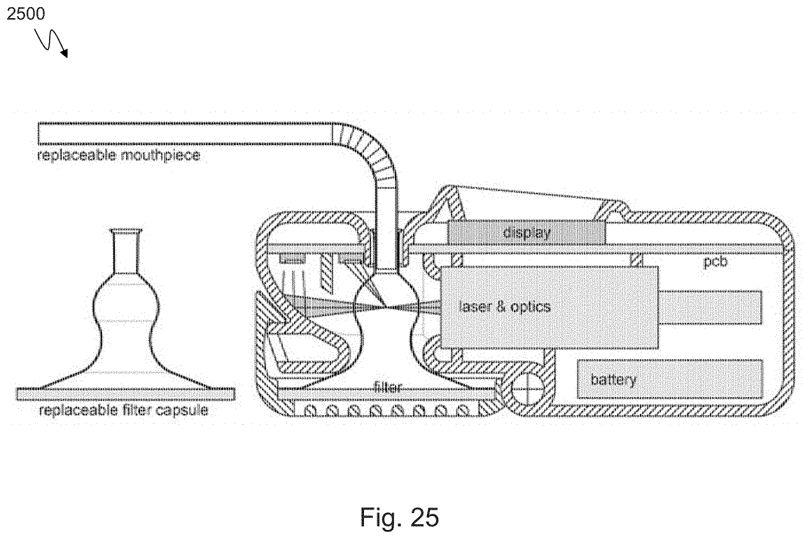

FIG. 25 illustrates in cross-sectional view, a hand-held breathalyser second embodiment in accordance with an aspect of disclosure with a disposable mouthpiece, coupled to a disposable outlet filter capsule incorporating a transparent spherical region centred upon the laser focus to contain the particles as they pass through the capsule including the laser focus vertically downward, said transparent spherical region being designed such that light rays traverse the thickness of its walls without de-focusing, said disposable capsule preventing contamination of the interior of the disclosure. In the embodiment shown, the mouth-piece may be formed of a straw that is disposable and/or one time use straw. The second embodiment also includes a different replaceable outlet filter which may also be single and/or multiple use. The outlet filter forms the chamber in which particles are impinged with light and from which detectors can obtain signals responsive to scattered light.

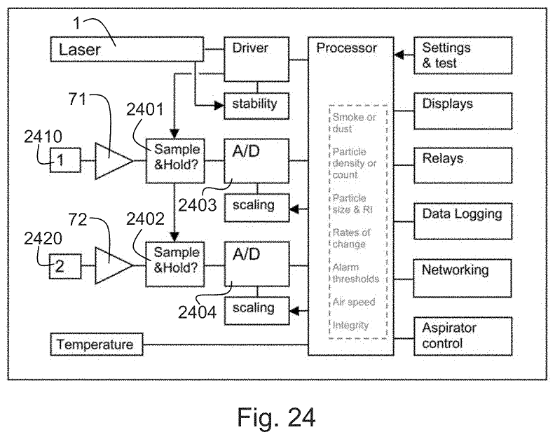

FIG. 24 illustrates a signal Processing Schematic of one embodiment of the present disclosure comprising a laser 1 controlled by a laser drive circuit with stability control. A first receiver 71 with matching amplifier responsive to a first input 2410 produces a first signal, connecting to a sample-and-hold circuit 2401 that serves to capture the amplitude of a first signal for subsequent processing. A second receiver 72 with matching amplifier responsive to a second input 2420 produces a second signal, connecting to a sample-and-hold circuit 2402 that serves to capture the amplitude of the second signal for subsequent processing. The first signal is presented to an analog-to-digital converter 2403 which has scaling feedback to handle a wide dynamic range of signal levels. Similarly, the second signal is presented to an analog-to-digital converter 2404 which has scaling feedback to handle a wide dynamic range of signal levels. These digital signals are presented to the signal processor 2505 (a microprocessor) which contains software to control the process as described herein, and for example, as described in the flowchart of FIG. 11. Having determined and accumulated the data for each particle size and refractive index, suitable displays and alarm outputs are operated. If an aspirator is fitted, this may be controlled and adjusted in accordance with the aerosol temperature. The ambient temperature determines the air (or fluid) density, which affects the air velocity (flow rate) and pressures throughout the aspirated pipe length. This in turn affects the response time to an event.

While this disclosure has been described in connection with specific embodiments thereof, it will be understood that it is capable of further modification(s). This application is intended to cover any variations uses or adaptations of the disclosure following in general, the principles of the disclosure and including such departures from the present disclosure as come within known or customary practice within the art to which the disclosure pertains and as may be applied to the essential features hereinbefore set forth.

As the present disclosure may be embodied in several forms without departing from the spirit of the essential characteristics of the disclosure, it should be understood that the above described embodiments are not to limit the present disclosure unless otherwise specified, but rather should be construed broadly within the spirit and scope of the disclosure. The described embodiments are to be considered in all respects as illustrative only and not restrictive.

Various modifications and equivalent arrangements are intended to be included within the spirit and scope of the disclosure. Therefore, the specific embodiments are to be understood to be illustrative of the many ways in which the principles of the present disclosure may be practiced. In the following disclosure, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

Various embodiments of the disclosure may be embodied in many different forms, including computer program logic for use with a processor (e.g. a microprocessor, microcontroller, digital signal processor, or general purpose computer and for that matter, any commercial processor may be used to implement the embodiments of the disclosure either as a single processor, serial or parallel set of processors in the system and, as such, examples of commercial processors include, but are not limited to Merced™, Pentium™, Pentium II™ Xeon™, Celeron™, Pentium Pro™, Efficeon™, Athlon™, AMD™ and the like), programmable logic for use with a programmable logic device (e.g. a Field Programmable Gate Array (FPGA) or other PLD), discrete components, integrated circuitry (e.g. an Application Specific Integrated Circuit (ASIC)), or any other means including any combination thereof. In an example embodiment of the present disclosure, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g. forms generated by an assembler, compiler, linker, or locator). Source code may include a series of computer program instructions implemented in any of various programming languages (e.g. an object code, an assembly language, or a high-level language such as Fortran, C, C++, JAVA, or HTML. Moreover, there are hundreds of available computer languages that may be used to implement embodiments of the disclosure, among the more common being Ada; Algol; APL; awk; Basic; C; C++; Cobol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g. via an interpreter), or the source code may be converted (e.g. via a translator, assembler, or compiler) into a computer executable form.

The computer program may be fixed in any form (e.g. source code form, computer executable form, or an intermediate form) either permanently or transitorily in a tangible storage medium, such as a semiconductor memory device (e.g. a RAM, ROM, PROM, EEPROM, or Flash-Programmable RAM), a magnetic memory device (e.g. a diskette or fixed disk), an optical memory device (e.g. a CD-ROM or DVD-ROM), a PC card (e.g. PCMCIA card), or other memory device. The computer program may be fixed in any form in a signal that is transmittable to a computer using any of various communication technologies, including, but in no way limited to, analog technologies, digital technologies, optical technologies, wireless technologies (e.g. Bluetooth), networking technologies, and inter-networking technologies. The computer program may be distributed in any form as a removable storage medium with accompanying printed or electronic documentation (e.g. shrink-wrapped software), preloaded with a computer system (e.g. on system ROM or fixed disk), or distributed from a server or electronic bulletin board over the communication system (e.g. the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g. VHDL or AHDL), or a PLD programming language (e.g. PALASM, ΔBEL, or CUPL). Hardware logic may also be incorporated into display screens for implementing embodiments of the disclosure and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g. a RAM, ROM, PROM, EEPROM, or Flash-Programmable RAM), a magnetic memory device (e.g. a diskette or fixed disk), an optical memory device (e.g. a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g. Bluetooth), networking technologies, and internetworking technologies. The programmable logic may be distributed as a removable storage medium with accompanying printed or electronic documentation (e.g. shrink wrapped software), preloaded with a computer system (e.g. on system ROM or fixed disk), or distributed from a server or electronic bulletin board over the communication system (e.g. the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description, the words “comprise”, “comprising”, “includes”, “including” and the like are to be construed in an inclusive sense as opposed to an exclusive or exhaustive sense; that is to say, in the sense of “including, but not limited to”.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of determining, in a fluid sample, the presence of particle(s) having a predetermined size or range of sizes within a detection zone using a particle detector, the method comprising:
providing a light beam adapted to illuminate the fluid sample within the detection zone;
providing a first sensor means adapted to obtain a first response signal responsive to light from the light beam scattered from a particle in the fluid sample at a first polarisation;
providing a second sensor means adapted to obtain a second response signal responsive to light from the light beam scattered from a particle in the fluid sample at a second polarisation;
based on the first response signal and the second response signal provided by the particle, determining a light scattering intensity at each of the first and second polarisations and a quotient thereof; and
determining size of particle(s) by correlating values of each of the light scattering intensities with values stored in a look-up table.

2. The method as claimed in claim 1, wherein the light beam is polarised.

3. The method as claimed in claim 1, wherein the values stored in the look-up table are obtained with reference to light scattering equations of Gustav Mie, and being applicable to wavelength and/or polarisations of application of the method.

4. The method as claimed in claim 3, wherein the values stored in the look-up table are obtained through a machine learning process where the method is used in association with a range of known particle species in order to characterise said species, and the intensities of scattered light obtained are stored in the look-up table for reference in identifying that species.

5. The method as claimed in claim 4, wherein the look-up table includes a quotient of the values obtained with reference to determining the particle size and refractive index of particle(s).

6. The method as claimed in claim 1, wherein correlating light intensity and/or the quotient determines size and also refractive index of particle(s).

7. The method as claimed in claim 6, wherein the light intensity is measured as an amplitude.

8. The method as claimed in claim 1, wherein the first sensor means is responsive to normal polarisation light.

9. The method as claimed in claim 1, wherein the second sensor means is responsive to parallel polarisation light.

10. The method as claimed in claim 1, wherein the quotient is determined by the following equation:
Quotient (Q)=GN/GP
where:
GN is a signal received by a first receiver with Normal polarisation; and
GP is a signal received by a second receiver with Parallel polarisation.

11. The method as claimed in claim 5, wherein the particle is or is indicative of SARS-CoV-2.

12. A particle detector adapted to determine, in a fluid sample, the presence of particle(s) having a predetermined size or range of sizes within a detection zone, the particle detector comprising:
a light source adapted to provide both a light beam adapted to illuminate the fluid sample within the detection zone;
first sensor means adapted to obtain a first response signal indicative of the presence of particle(s) responsive to light from the light beam scattered from a particle in the fluid sample at a first polarisation;
second sensor means adapted to obtain a second response signal indicative of the presence of particle(s) responsive to light from the light beam scattered from a particle in the fluid sample at a second polarisation; and
logic means adapted to process the first response signal and the second response signal in order to determine the presence of particle(s) responsive to each polarisation of scattered light based on reference to light intensity values stored in a look-up table.

13. The particle detector as claimed in claim 12, wherein the light beam is polarised.

14. The particle detector as claimed in claim 12, wherein the values stored in the look-up table are obtained with reference to light scattering equations of Gustav Mie, and being applicable to wavelength and/or polarisations of application of the method.

15. The particle detector as claimed in claim 12, wherein the values stored in the look-up table are obtained through a machine learning process where the method is used in association with a range of known particle species in order to characterise said species, and the intensities of scattered light obtained are stored in the look-up table for reference in identifying said species.

16. The particle detector as claimed in claim 12, wherein the look-up table includes a quotient of values obtained with reference to determining the particle size and refractive index of particle(s).

17. The particle detector as claimed in claim 12, wherein the first sensor means is responsive to normal polarisation light and further wherein the second sensor means is responsive to parallel polarisation light.

18. The particle detector as claimed in claim 12, wherein the light source is a single wavelength light source.

19. The particle detector as claimed in claim 12, wherein the light source is a polarised light source.

20. The particle detector as claimed in claim 12, wherein the particle is or is indicative of SARS-CoV-2.

21. A method of detecting size or range of sizes of at least one particle in a fluid sample, the method comprising:
providing a detection zone;
providing, in the detection zone, a light beam;
providing a first detector adapted to receive first scattered light at a first polarisation from a particle in the detection zone in response to the light beam and in response to a fluid flow containing particle(s) in the detection zone;
providing a second detector adapted to receive second scattered light at a second polarisation from a particle in the detection zone in response to the light beam and also in response to the fluid flow containing particle(s) in the detection zone; and
by using output(s) of the first detector and/or the second detector, determining the size or range of sizes of at least one particle in the fluid sample based on at least intensity of the first scattered light and/or intensity of the second scattered light at a refractive index or a range of refractive indices.

22. The method as claimed in claim 21, wherein the intensity of the first and second scattered light is used.

23. The method as claimed in claim 21, wherein the determination is displayed and represents a number of particles counted at each refractive index and/or particle size.

24. A detector adapted to operate in accordance with the method of claim 1.

25. A particle detection zone adapted for use with a particle detector for detecting size or range of sizes of at least one particle in a fluid sample, the particle detection zone comprising:
a disposable outlet filter capsule incorporating a transparent spherical region forming a chamber and adapted, in association with the particle detector, to be located proximate an area of laser focus, the chamber forming a zone in which particles are impinged with light from the laser and from which light scattered in response to the presence of particles can be emitted to obtain signals for processing by the particle detector.
